(19) United States
(12) Patent Application Publication
(10) Pub. No.: US 2003/0101140 A1
(43) Pub. Date: May 29, 2003

(54) Recording medium and copy apparatus

(76) Inventors: Hirokazu So, Moriguchi (JP); Shinji Inoue, Neyagawa (JP); Takuji Maeda, Neyagawa (JP); Makoto Ochi, Hirataka (JP); Takayuki Ito, Kadoma (JP)

Correspondence Address: WENDEROTH, LIND & PONACK, L.L.P., 2033 K STREET N. W., SUITE 800, WASHINGTON, DC, 20006-1021, US

(21) Appl. No.: 10/292,703

(22) Filed: Nov. 13, 2002

(30) Foreign Application Priority Data
Nov. 27, 2001 (JP) 2001-360545

(51) Int. Cl. G06F 17/60

(52) U.S. Cl. 705/51

(57) ABSTRACT

A recording medium and copy apparatus reduce user confusion when copying digital data recorded on a recording medium by notifying the user in advance of copy control information embedded in the digital data as a watermark or the like.

The recording medium on which the digital data is recorded is composed of a content data storage area, a display-use copy control information storage area that stores display-use copy control information that is for displaying copy control information when copying, and an index information storage area. Since the display-use copy control information in the display-use copy control information storage area is identical to copy control information embedded in the digital data, the copy apparatus is able to notify the user of the copy control information before copying the digital data.

### BACKGROUND OF THE INVENTION

(1) Field of the Invention

The present invention relates to a recording medium having digital data recorded thereon, and a copy apparatus that copies the digital data, and in particular to a method for copying digital data that is copyright protected with use of a watermark technique.

(2) Description of the Related Art

Conventionally optical disks such as laser disks (LDs), compact disks (CDs), mini disks (MDs) and DVDs (Digital Versatile Disks) are widely used as recording mediums for storing digital data such as music data and moving image data (hereinafter called “content data”). More recently, semiconductor memories are showing signs of becoming more widespread. This is because semiconductor memories are compact compared to the aforementioned optical disks and do not have a problem of jumps in sound.

An exact copy of content data that is recorded on a recording medium such as those described above can be made easily. In order to prevent this, copying of such content data is controlled by using a digital work protection technique such as an SCMS (Serial Copy Management System) or a watermark technique.

SCMS is an international technical specification whose object is to restrict digital copying from a CD or the like over multiple generations, and thus limit the digital copying to one generation. Digital music devices manufacture employing this system react to copy control information that is recorded on digital recording mediums, such as CDs, MDs, DATs (Digital Audio Tapes) and CD-R (Compact Disk Recordable). For example, when content data is dubbed to an MD from a CD that has recorded thereon a signal showing that only a first generation copy is permitted, the digital recording device converts the signal to a signal showing that copying is not permitted, and records the converted signal to the MD. When there is an attempt to copy content data from the MD to another MD, the digital recording device reacts to the signal that shows that copying is not permitted, and stops recording.

Watermark techniques, which are showing signs of becoming popular in recent years, have the advantage of making tampering difficult because using such a technique enables copy control information to be embedded directly in content data such as music data and moving image data. Japanese laid-open patent applications H11-86436 and 2000-23089 disclose copy control methods that use watermark techniques.

Copy control information that is embedded as a watermark in content data is obtained by reading all or part of the content data. For example, SDMI (Secure Digital Music Initiative), which develops specifications regarding copyright protection of digital music content, specifies a method for extracting watermarks from music content data (Amendment 1 to SDMI Portable Device Specification, Part I, Version 1.0, Sep. 23, 1999). In this specification an embedded watermark must be detected in music content data every 15 seconds. When a user designates copying of content data, the copy apparatus performs copy processing while simultaneously detecting watermarks that show that copying is permitted in the original content data. When the copy apparatus detects a watermark showing in the original content data showing that copying is not permitted, the copy apparatus stops copying and then deletes the copy that has been made of the content data.

However, while watermark techniques have the advantage of making tampering with content data difficult, a disadvantage of such techniques is that the user does not know that content data is not permitted to be copied until after he or she has started copying the content data. In addition, the copy of the section of the content data that has already been made must be deleted after copying is stopped. This means that time is required to read all or part of the content data, and then further required to delete the copy that has been when it is discovered that the content data is not permitted be copied. This gives rise to a problem that time is wasted before it is judged that copying is not permitted.

### SUMMARY OF THE INVENTION

To solve this problem, the object of the present invention is to provide a copy apparatus and a recording medium that reduce the time required to judge whether copying of a digital work is permitted or not compared to conventional art.

The recording medium of the present invention has a digital work and display-use copy information recorded thereon. Embedded copy control information is embedded in the digital work with use of a watermark technique. The display-use copy control information and the embedded copy control information show a restriction relating to copying the digital work. The copy apparatus of the present invention reads the display-use copy control information from the recording medium, uses the read display-use copy control information to generate display information showing the restriction, and outputs the generated display information.

In this way, the copy apparatus reads only the display-use copy control information to output the display information, without reading the digital work from the recording medium, therefore the copy apparatus is able to present information for judging whether the digital work is permitted to be copied or not to the user more quickly than conventional art.

The copy apparatus of the present invention includes a display-use copy control information acquisition unit that reads the display-use copy control information from the recording medium, and a copy control information display unit that, before copying the digital work, displays and notifies the user of copy control information, based on the display-use copy control information.

Here, the copy apparatus may further include a unit for updating the display-use copy control information on the recording medium as necessary. Furthermore, the display-use copy information acquisition unit may include a communication sub-unit that communication with an external network, and acquire display-use copy control information of the digital work via the network.

Furthermore, it is possible for the recording medium not to have the display-use copy control information stored thereon. In such a case, the copy apparatus of the present invention further includes: a copy control information detection unit that detects embedded copy control information in the digital work recorded on the recording medium; a copy control information list creation unit that creates a list of the copy control information detected by the copy control information detection unit; a copy control information list storage unit that stores the copy control information list; and a copy control information display unit that, before the digital work is copied, displays and notifies the user of copy control information. The copy control information list creation unit may create a copy control information list during playback or during copying of the digital work on the recording medium. Furthermore, the copy control information list creation unit may have a communication sub-unit that communicates with an external network, and create the copy control information list by acquiring copy control information of the digital work from the external network.

### BRIEF DESCRIPTION OF THE DRAWINGS

These and other objects, advantages and features of the invention will become apparent from the following description thereof taken in conjunction with accompanying drawings which illustrate a specific embodiment of the invention. In the drawings:

FIG. 1 is a block diagram showing the structure of a content copy system 1;

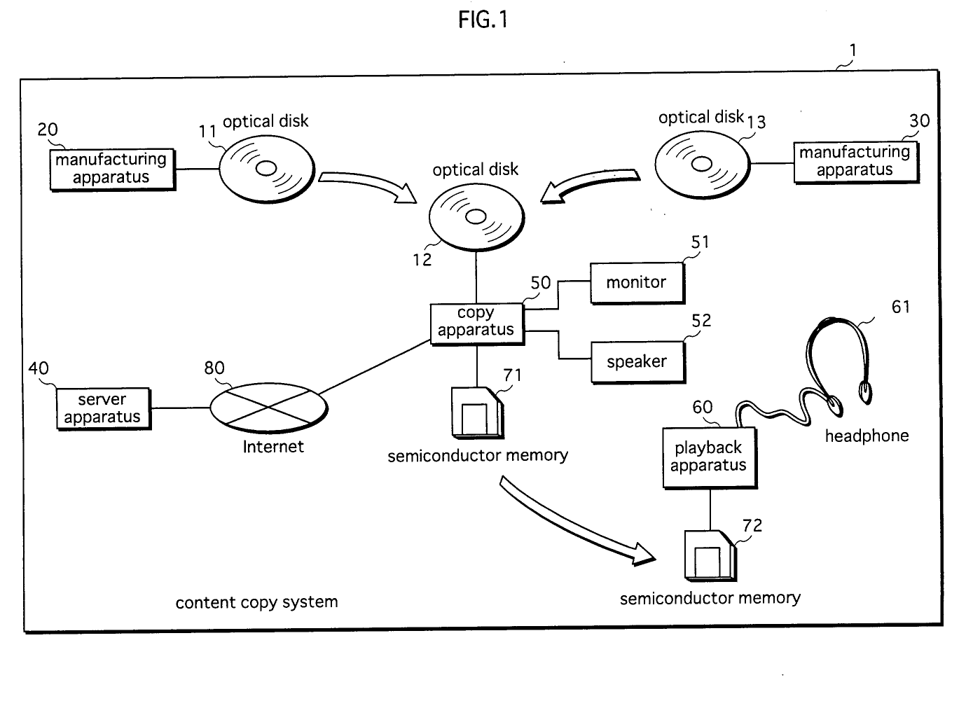

FIG. 2 is a block diagram showing the structure of a manufacturing apparatus 20;

FIG. 3 shows the data structure of an optical disk;

FIG. 4 shows the data structure of an optical disk, and in particular scene copy control information and scene information;

FIG. 5 is a table showing copy control information bit strings and their corresponding meanings;

FIG. 6 is a block diagram of the structure of a server apparatus 40;

FIG. 7 shows a block diagram of a copy apparatus 50, and the data structure of a semiconductor memory 71;

FIG. 8 shows an example of information displayed by a display unit 505;

FIG. 9 shows the data structure of a list stored by a list storage unit 503;

FIG. 10 is a flowchart showing operations by the manufacturing apparatus 20;

FIG. 11 is a flowchart showing an outline of operations by the copy apparatus 50, and continues in FIG. 12;

FIG. 12 is a flowchart showing an outline of operations by the copy apparatus 50, and continues from FIG. 11;

FIG. 13 is a flowchart showing operations by the copy apparatus 50 for generating a list, and continues in FIG. 14;

FIG. 14 is a flowchart showing operations by the copy apparatus 50 for generating a list, and continues from FIG. 13;

FIG. 15 is a flowchart showing operations by a list generation unit 502 of the copy apparatus 50 for checking display-use copy control information, and continues in FIG. 16;

FIG. 16 is a flowchart showing operations by a list generation unit 502 of the copy apparatus 50 for checking display-use copy control information, and continues from FIG. 15;

FIG. 17 is a flowchart showing operations of a menu generation unit 504 and the display unit 505 of the copy apparatus 50 for displaying a content menu;

FIG. 18 is a flowchart showing operations by the copy apparatus 50 for content data copy processing (1);

FIG. 19 is a flowchart showing operations by the copy apparatus 50 for content data scene copy processing (1);

FIG. 20 is a flowchart showing operations by the copy apparatus 50 for content data copy processing (2); and

FIG. 21 is a flowchart showing operations by the copy apparatus 50 for content data scene copy processing (2).

### DESCRIPTION OF THE PREFERRED EMBODIMENT

The following describes a content copy system 1 as an embodiment of the present invention.

### 1. Structure of the Content Copy System 1

The content copy system 1 is composed of a manufacturing apparatus 20, a manufacturing apparatus 30, a server apparatus 40, a copy apparatus 50 and a playback apparatus 60.

The manufacturer of an optical disk having content recorded thereon has possession of the manufacturing apparatus 20. The manufacturing apparatus 20 manufactures an optical disk 11 on which is recorded one or more contents, and one or more pieces of copy control information for display purposes (hereinafter “display-use copy control information”) which correspond respectively to the contents. Each content is, for example, digital data of music, and copy control information is embedded in the digital data (hereinafter “embedded copy control information”). Here, each piece of display-use copy control information and embedded copy control information shows a restriction relating to copying the corresponding content. A user obtains the optical disk 11 by any of various distribution routes.

Another manufacturer who manufactures optical disks having content recorded thereon has possession of the manufacturing apparatus 30. The manufacturing apparatus 30 manufactures an optical disk 12 on which one or more contents are recorded. The contents are, for example, digital data of music in which embedded copy control information is embedded. A user obtains the optical disk 12 also by any of various distribution routes.

The user has possession of the copy apparatus 50. The copy apparatus 50 is connected to the server apparatus 40 via the Internet 80. The user loads the optical disk 11 or the optical disk 12 manufactured by the manufacturing apparatus 20 or the manufacturing apparatus 30, respectively, and a semiconductor memory 71 in the copy apparatus 50. When the optical disk 11 is loaded in the copy apparatus 50, the copy apparatus 50 reads the display-use copy control information, and displays the copy restriction for each content recorded on the optical disk 11 with use of the read display-use copy control information. When the optical disk 12 is loaded in the copy apparatus 50, the copy apparatus 50 obtains display-use copy control information via the Internet 80 from the server apparatus 40, and displays the copy restriction for each content recorded on the optical disk 12 with use of the obtained display-use copy control information.

The user uses the copy restrictions displayed by the copy apparatus 50 as a basis for selecting content. The copy apparatus 50 reads the selected content from the optical disk, decrypts, expands, further encrypts, and compresses the read content to generate content of a different format, and writes the generated content to the semiconductor memory 71.

The user loads the semiconductor memory 71 to which the newly generated content has been written in the playback apparatus 60. The playback apparatus 60 reads the content from the semiconductor memory 71, decrypts and expands the read content which it then converts to an audio signal, and outputs the audio signal to headphones 61.

In this way, the user copies content recorded on an optical disk to a semiconductor memory.

1.1 Manufacturing Apparatus 20

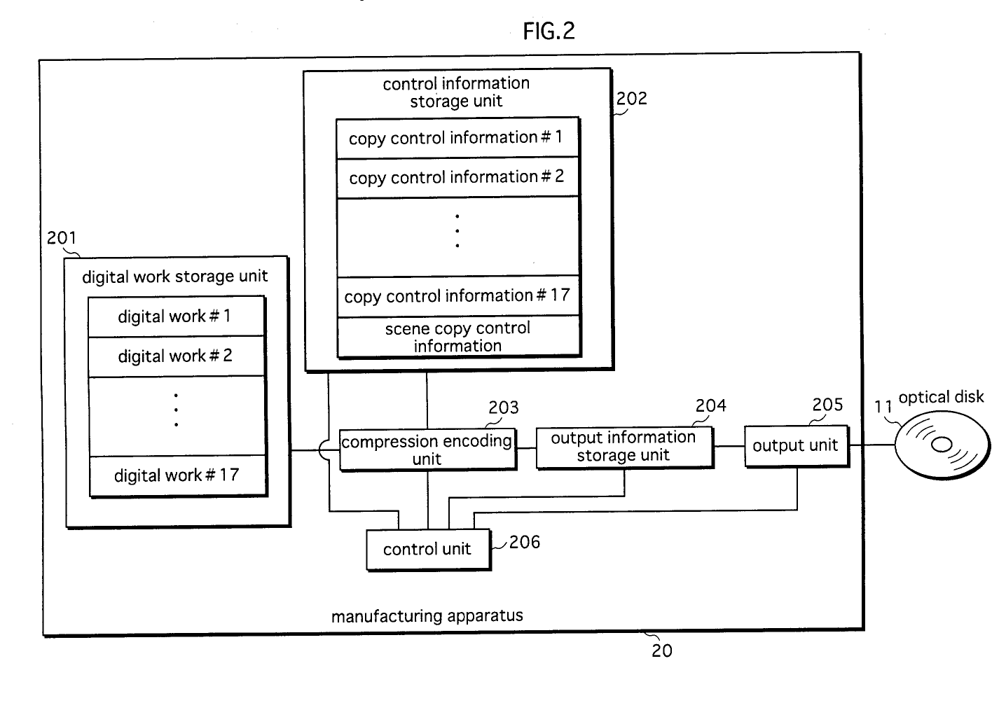

As shown in FIG. 2, the manufacturing apparatus 20 is composed of a digital work storage unit 201, a control information storage unit 202, a compression encoding unit 203, an output information storage unit 204, an output unit 205 and a control unit 206.

Specifically, the manufacturing apparatus 20 is a computer system composed of a microprocessor, a ROM (Read Only Memory), a RAM (Random Access Memory), a hard disk unit, a display unit, a keyboard, a mouse and so on. A computer program is stored in the hard disk unit. The manufacturing apparatus 20 achieves its functions by the microprocessor operating in accordance with the computer program.

(1) Digital Work Storage Unit 201

As shown in FIG. 2, the digital work storage unit 201 stores seventeen digital works #1 to #17. Digital work #3 is digital data of a movie. Each of the other digital works is digital data of either music or a movie.

The digital work #3 is composed of 99 scenes, each of which is composed of a plurality of image segments.

Note that the digital work storage unit 201 is not limited to storing seventeen digital works as described here, but may instead store more digital works or less digital works. Furthermore, although the digital work #3 is digital data of a movie here, the other digital works may be digital data of a movie. Furthermore, the digital work #3 is not limited to being composed of 99 scenes, but may instead be composed of more scenes or less scenes.

(2) Control Information Storage Unit 202

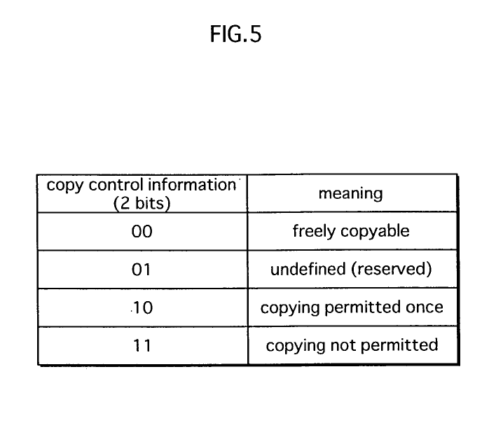

As shown in FIG. 2, the control information storage unit 202 stores seventeen pieces of copy control information #1 to #17, and copy control information for the scenes (hereinafter “scene copy control information”). The pieces of copy control information, each of which is composed of two bits, correspond respectively to the seventeen digital works #1 to #17 stored in the digital work storage unit 201, and each piece shows a restriction relating to copying the corresponding digital work. As shown in FIG. 5, each piece of copy control information has a value “00”, “01”, “10” or “11”. “00” shows that the corresponding digital work is freely copyable. “01” is currently reserved for expansion of the uses of copy control information, and is undefined. “10” shows that the corresponding digital work is permitted to be copied once only. “11” shows that copying of the corresponding digital work is not permitted.

The scene copy control information corresponds to the digital work #3 stored in the digital work storage unit 201, and includes 99 pieces of copy control information #101 to #199. The pieces of copy control information #101 to #199 correspond respectively to the 99 scenes of the digital work #3, and each piece shows a restriction relating to copying the corresponding scene. Each piece of copy control information #101 to #199 has a value “00”, “01”, “10” or “11”. The meanings of these values are as described earlier. Here, the value of the copy control information #3 is representative of the copy control information #101 to #199, and is the same value as the piece of copy control information amongst the copy control information #101 to #199 that shows the least strict restriction.

Note that the copy control information #3 is not limited to having the same value as the piece of copy control information amongst the copy control information #101 to #199 that shows the least strict restriction. The value of the copy control information #3 may be the same as that of the piece of copy control information amongst the copy control information #101 to #199 that shows the strictest restriction, or may be another value. Furthermore, instead of being information for controlling copying, the copy control information #3 may have a value that shows that scene copy control information exists.

(3) Output Information Storage Unit 204

The output information storage unit 204 has an area for storing a media identifier, index information, seventeen pieces of display-use copy control information, scene copy control information, and seventeen pieces of content data.

(4) Compression Encoding Unit 203

Under the control of the control unit 206, the compression encoding unit 203 reads a digital work from the digital work storage unit 201, and reads the copy information corresponding to the digital work. Then the compression encoding unit 203 compression encodes the read digital work while embedding the read copy information therein, encrypts the result to generate content data, and writes the generated content data to the output information storage unit 204.

Here, for each scene in the digital work #3, the compression encoding unit 203 embeds the copy control information corresponding to the scene in the scene and compression encodes the scene, then encrypts the scene to generate scene information. Next, the compression encoding unit 203 writes content data composed of 99 pieces of scene information to the output information storage unit 204.

(5) Output Unit 205

Under the control of the control unit 206, the output unit 205 writes the media identifier, the index information, the seventeen pieces of display-use copy control information, scene display-use copy control information and the seventeen pieces of content data written to the output information storage unit 204 respectively to a unique ID storage area 101, an index information storage area 102, a display-use copy control information storage area 103 and a content data storage area 104 in the optical disk 11.

(6) Control Unit 206

The control unit 206 generates a media identifier that identifies the optical disk, and writes the generated media identifier to the output information storage unit 204.

The control unit 206 also performs the following (a) and (b) for each digital work stored in the digital work storage unit 201.

(a) The control unit 206 controls so that the corresponding copy control information is read from the control information storage unit 202 and embedded in the digital work, and the digital work in which the copy control information is embedded is compression encoded. Furthermore, the control unit 206 controls so that the compression encoded digital work is encrypted, to generate the content data, and the generated content data is written to the output information storage unit 204.

Here, for each scene in the digital work #3, the control unit 206 controls so that the copy control information corresponding to the scene is embedded in the scene, and the scene is compression encoded and then encrypted to generate scene information. Next, the control unit 206 controls so that the content data composed of 99 pieces of scene information is written to the output information storage unit 204.

(b) The control unit 206 controls so that the read copy control information is written to the output information storage unit 204 as display-use copy control information, and so that the scene copy control information is written to the output information storage unit 204 as scene display-use copy control information.

Next, the control unit 206 generates index information for searching the content data on the optical disk, and writes the generated index information to the output information storage unit 204.

The control unit 206 then controls the output unit 205 so that the output unit 205 writes the media identifier, the index information, the seventeen pieces of display-use copy control information, the scene display-use copy control information and the seventeen pieces of content data written to the output information storage unit 204 respectively to the unique ID storage area 101, the index information storage area 102, the display-use copy control information storage area 103 and the content data storage area 104 in the optical disk 11.

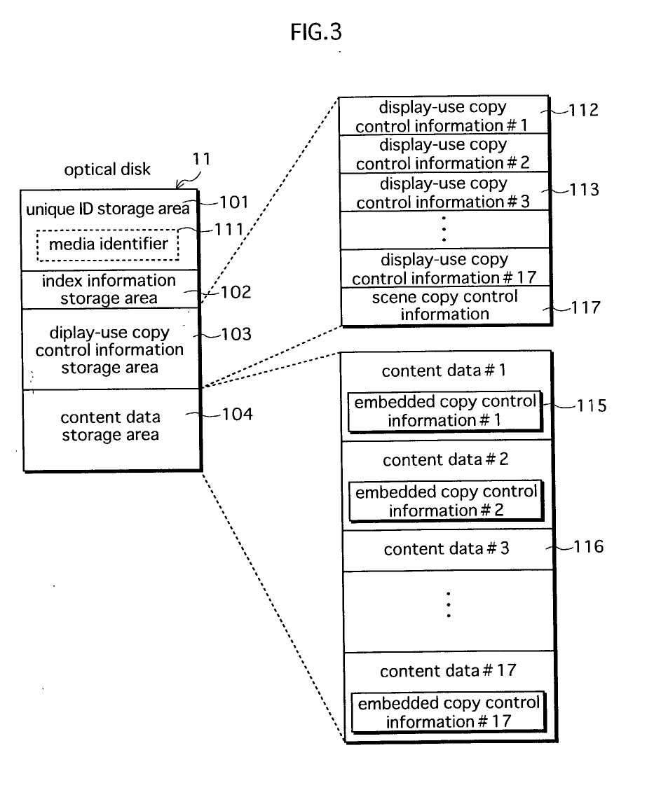

FIG. 3 shows the data structure of the optical disk 11 to which information has been written in the above-described manner.

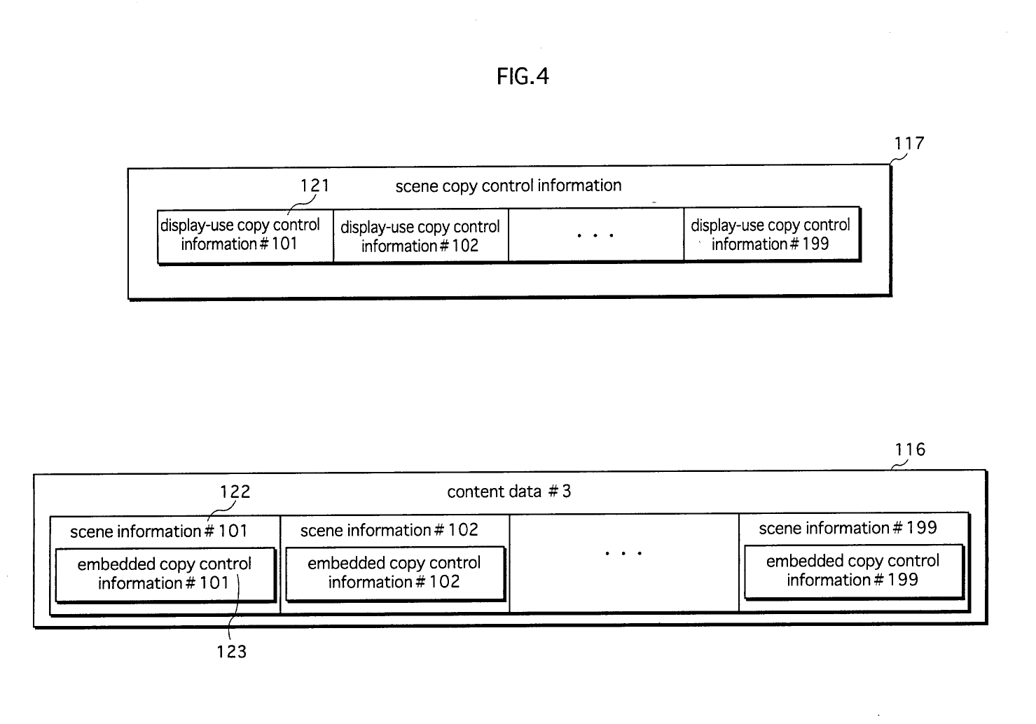

As FIGS. 3 and 4 show, the optical disk 11 has the unique ID storage area 101, the index information storage area 102, the display-use copy control information storage area 103 and the content data storage area 104.

The media identifier 111 is recorded in the unique ID storage area 101. The media identifier may be any identifier as long as it is unique to the optical disk that is the recording medium. In the present embodiment, the media identifier is a set composed of the ISRC (International Standard Recording Code) code of each piece of content data that is stored in the content data storage area 104. The ISRC code is a product-unique identifier that is given to only one music product in the world.

The index information is stored in the index information storage area 102, and is information that is necessary when the copy apparatus extracts the content data stored in the content data storage area 104 and the display-use copy control information stored in the display-use copy control information storage area 103. In other words, the index information storage area 102 stores recording addresses and the like. In the present embodiment recording addresses and the like are managed in a FAT (File Allocation Table) file system, and the necessary information for the FAT is recorded in the index information storage area 102. Note that it is possible to use other file systems such as a UDF (Universal Disk Format), or to manage the recording addresses without using a file system.

The seventeen pieces of display-use copy control information #1 to #17, and the scene display-use copy control information are recorded in the display-use copy control information storage area 103. The seventeen pieces of content data #1 to #17 are recorded in the content data storage area 104.

As shown in FIG. 4, the scene display-use copy control information is composed of ninety-nine pieces of display-use copy control information #101 to #199. The content data #3 is composed of ninety-nine pieces of scene information #101 to #199. The pieces of display-use copy control information #101 to #199 correspond respectively to the pieces of scene information #101 to #199, and pieces of embedded copy control information #101 to #199 are embedded respectively in the pieces of scene information #101 to #199.

1.2 Manufacturing Apparatus 30

The manufacturing apparatus 30 has a similar structure to the manufacturing apparatus 20.

The difference between the manufacturing apparatus 20 and the manufacturing apparatus 30 is that the manufacturing apparatus 30 does not write the pieces of display-use copy control information #1 to #17 and the scene copy control information to the optical disk 12.

The optical disk 12 has a unique ID storage area, an index information storage area and a content data storage area, but does not have a display-use copy control information storage area.

The information recorded in the unique ID storage area, the index information storage area and the content data storage area is the same as that recorded in the respective areas in the optical disk 11.

1.3 Server Apparatus 40

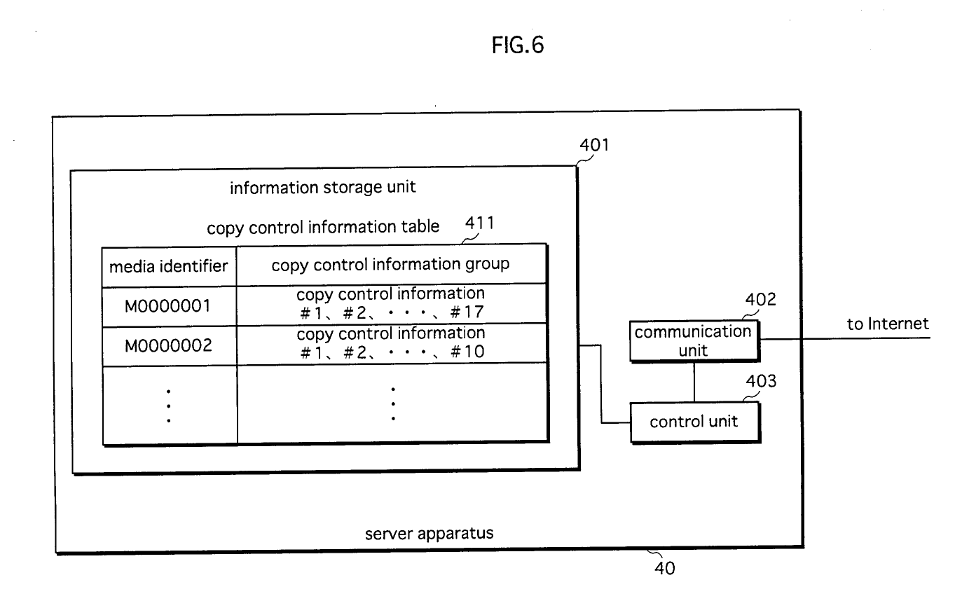

As shown in FIG. 6, the server apparatus 40 is composed of an information storage unit 401, a communication unit 402 and a control unit 403.

The server apparatus 40 is a computer system similar to the manufacturing apparatus 20, and achieves its functions by a microprocessor operating in accordance with a computer program.

(1) Information Storage Unit 401

The information storage unit 401 has a copy control information table 411, such as shown in FIG. 6 as one example.

The copy control information table 411 stores in advance a plurality of pieces of copy association information, each piece of which is composed of a media identifier and a copy control information group.

Each piece of copy association information corresponds to an optical disk.

The media identifier is identification information for identifying an optical disk.

The copy control information group includes pieces of copy control information equal in number to the pieces of content data. The pieces of copy control information correspond respectively to the pieces of content data recorded on the optical disk, and each piece shows a restriction relating to copying the corresponding piece of content data. Each piece of copy control information is composed of two bits, the meanings of the values of which are as shown in FIG. 5.

(2) Control Unit 403

The control unit 403 receives a media identifier from the copy apparatus 50 via the Internet 80 and the communication unit 402. On receiving the media identifier, the control unit 403 retrieves a media identifier that has the same value as the received media identifier from the copy control information table 411 in the information storage unit 401, extracts the copy control information group included in the same copy association information as the retrieved media identifier, and transmits the extracted copy control information group to the copy apparatus 50 via the communication unit 402 and the Internet 80.

(3) Communication Unit 402

The communication unit 402 is connected to the copy apparatus 50 via the Internet 80, and transmits and receives information between the control unit 403 and the copy apparatus 50.

1.4 Copy Apparatus 50

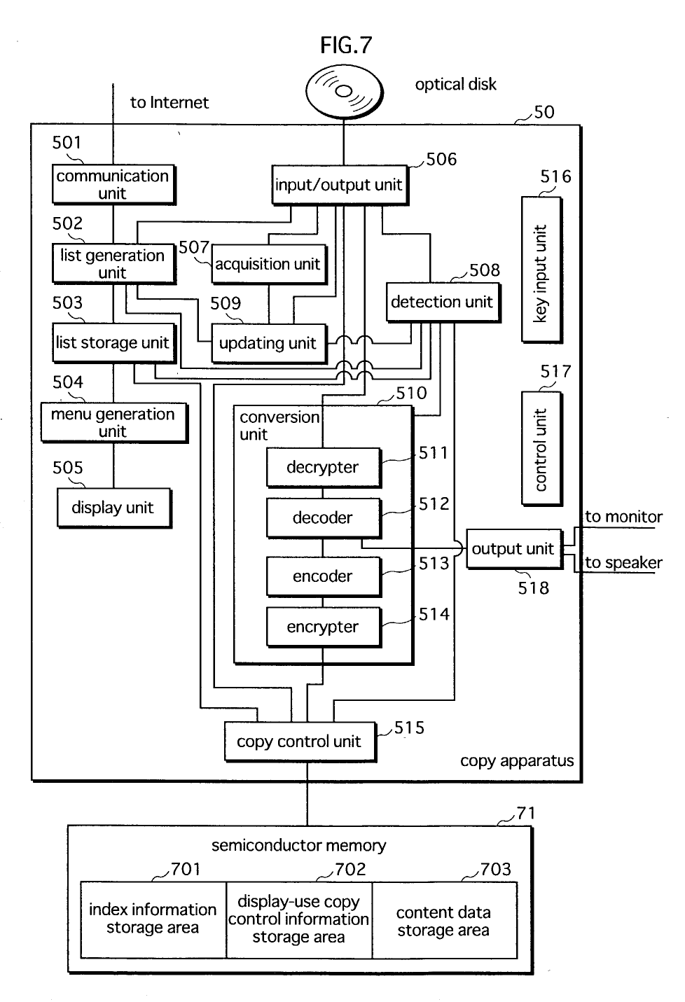

As shown in FIG. 7, the copy apparatus 50 is composed of a communication unit 501, a list generation unit 502, a list storage unit 503, a menu generation unit 504, a display unit 505, an input/output unit 506, an acquisition unit 507, a detection unit 508, an updating unit 509, a conversion unit 510, a copy control unit 515, a key input unit 516, a control unit 517 and an output unit 518. A monitor 51 that receives and displays video signals and a speaker 52 that receives and outputs audio signals are connected to the copy apparatus 50.

The copy apparatus 50 is a computer system similar to the manufacturing apparatus 20, and achieves its functions by a microprocessor operating in accordance with a computer program.

A specific example of the copy apparatus 50 is an audio record/playback apparatus that copies and plays back audio data.

(1) Communication Unit 501

The communication unit 501 is connected to the server 40 via the Internet 80, and transmits and receives information between the server apparatus 40 and the list generation unit 502.

Specifically, the communication unit 501 receives the media identifier from the list generation unit 502, and transmits the received media identifier to the server apparatus 40. In addition, the communication unit 501 receives the copy control information group from the server apparatus 40, and outputs the received copy control information group to the list generation unit 502.

(2) List Generation Unit 502

The list generation unit 502 has a check flag that is normally set to ON when the copy apparatus 50 is manufactured. Note that the check flag may be set to OFF when the copy apparatus 50 is manufactured.

The list generation unit 502 receives the media identifier from the input/output unit 506.

On receiving the media identifier, the list generation unit 502 searches the list storage unit 503 for a media identifier that is identical to the received media identifier. When there is an identical media identifier in the list storage unit 503, the list generation unit 502 ends the processing.

When there is no identical media identifier in the list storage unit 503 and a usage flag is judged to be ON by the acquisition unit 507, the list generation unit 502 judges via the input/output unit 506 whether display-use copy control information is recorded on the optical disk or not.

When it is judged that display-use copy control information is recorded on the optical disk, the list generation unit 502 reads all the display-use copy control information from the loaded optical disk via the input/output unit 506. Then, only when the check flag in the list generation unit 502 is ON, the list generation unit 502 checks the display-use copy control information as described later. The list generation unit 502 then writes a copy control information group composed of all the obtained copy control information in correspondence to the list storage unit 503, and ends the processing.

When it is judged that display-use copy control information is not recorded on the optical disk, the list generation unit 502 transmits the read media identifier to the server apparatus 40 via the communication unit 501 and the Internet 80. The list generation unit 502 then receives a copy control information group from the server apparatus 40 via the Internet 80 and the communication unit 501.

When the acquisition unit 507 judges that the usage flag is OFF, the list generation unit 502 receives embedded copy control information from the detection unit 508, writes the read media identifier and the received embedded copy control information to the list storage unit 503, writes the embedded copy control information to the list storage unit 503 in correspondence with the media identifier as display-use copy control information, and ends the processing.

<Checking the Display-Use Copy Control Information>

The list generation unit 502 repeats the following processing for digital work #i (i=1, 2, . . . , N).

1. The list generation unit 502 extracts embedded copy control information #i from the digital work #i recorded on the optical disk, via the input/output unit 506 and the detection unit 508.

2. The list generation unit 502 compares display-use copy control information #i stored in the list storage unit 503 and the extracted embedded copy control information #i. When the display-use copy control information #i and the extracted embedded copy control information #i are not identical, the list generation unit 502 then judges whether the copy restriction of the embedded copy control information #i is stricter than that of the display-use copy control information #i. When the judgement is positive, the list generation unit 502 replaces the value of the display-use copy control information #i recorded in the list storage unit 503 with the value of the embedded copy control information #i.

Here, a copy restriction being “strict” denotes the following.

Copy control information “11” (copying not permitted) is the strictest value of copy restriction. The next strictest value is “10” (copying permitted once). The least strict value is “00” (freely copyable).

3. On judging via the input/output unit 506 that the loaded optical disk is writable, the list generation unit 502 replaces the value of the display-use copy control information #i recorded on the optical disk with the value of the embedded copy control information #i.

Note that in the above-described processing, the list generation unit 502 is not limited to extracting the embedded information #i from the digital work #i recorded on the optical disk via the input/output unit 506 and the detection unit 508. Instead, the list generation unit 502 may have a function for extracting the embedded copy control information #i from the digital work #i recorded on the optical disk in the same manner as the detection unit 508, and extract the embedded copy control information #i from the digital work #i recorded on the optical disk via the input/output unit 506.

(3) List Storage Unit 503

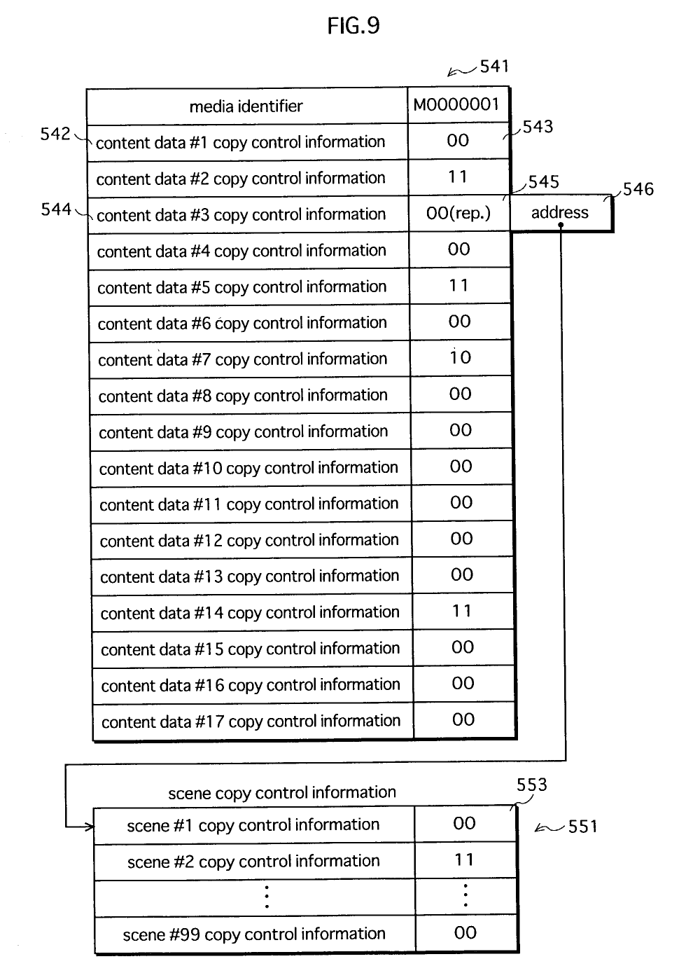

As shown in an example in FIG. 9, the list storage unit 503 includes an area 541 for storing a media identifier and a plurality of pieces of copy control information that correspond to the media identifier.

The media identifier, as has been described, is identification information for identifying the optical disk.

The copy control information is as shown in FIG. 5.

In cases in which the content data corresponding to the copy control information includes a plurality of pieces of scene information, addresses that show the area where each piece of scene copy control information is stored are made to correspond with the copy control information. The list storage unit 503 further includes an area 551 for storing the scene copy control information.

The pieces of scene copy control information correspond respectively to pieces of scene information included in the content data.

(4) Menu Generation Unit 504

The menu generation unit 504 first clears content that is being displayed by the display unit 505, then obtains the media identifier of the optical disk for which a content menu is to be displayed from the control unit 517, and sets a variable i to an initial value of “0”.

Next, the menu generation unit 504 tries to read the pieces of display-use copy control information in order from the list storage unit 503. On detecting that it has finished reading all the pieces, the menu generation unit 504 ends the processing.

On reading a piece of display-use copy control information from the list storage unit 503, the menu generation unit 504 adds a value “1” to the variable i. Then the menu generation unit 504 judges whether the read piece of display-use copy control information is either of “00” and “10”, or is “11”.

When the read piece of display-use copy control information is either of “00” and “10”, the menu generation unit 504 outputs a number i to the display unit 505. Here, the display unit 505 displays the number i in a position shown by the variable i.

Only when scene information is included in the content data corresponding to the read piece of display-use copy control information, the menu generation unit 504 further outputs a scene mark to the display unit 505. This scene mark is described in detail later. Here, the display unit 505 displays the scene mark in the position shown by the variable i overlaid on the number i.

On the other hand, when the read piece of display-use copy control information is “11”, the menu generation unit 504 outputs a character that is formed by overlaying the number i with a mark showing that copying is prohibited (hereinafter “copy prohibition mark”) to the display unit 505. This copy prohibition mark is described later. The display unit 505 displays the character in the position shown by the variable i.

Furthermore, the menu generation unit 504 attaches a flag showing that selection is not permitted to the particular piece of display-use copy control information stored in the list storage unit 503, and writes the attached flag to the list storage unit 503.

(5) Display Unit 505

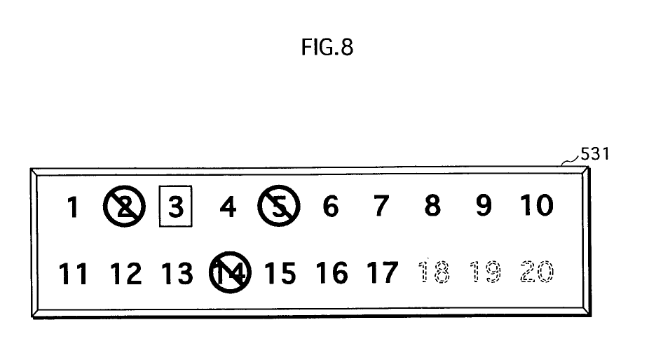

The display unit 505 includes an area 531 for displaying information. An example of the information displayed is numbers showing the content data stored on the optical disk, such as those shown in FIG. 8, and other information not illustrated here. A number that is displayed with a copy prohibition mark overlaid thereon shows that copying of corresponding content data is prohibited. A number that is displayed with a scene mark overlaid thereon shows that the corresponding content data is composed of a plurality of pieces of scene data, and that at least one of the pieces of scene data is permitted to be copied. Other numbers show that copying of the corresponding content data is permitted. Numbers displayed by broken lines show that content data corresponding to the numbers does not exist on the optical disk.

Here, the copy prohibition mark is in the form of a circle with a diagonal line therethrough. The scene mark is in the form of a rectangle.

In FIG. 8, there is no mark on numbers 1, 4, 6 to 13, and 15 to 17, showing that copying of the content data corresponding to these numbers is permitted.

Furthermore, copy prohibition marks are displayed on numbers 2, 5, and 14, showing that copying of the content data corresponding to these numbers is prohibited.

Furthermore, a scene mark is displayed on number 3, showing that the corresponding content data is composed of a plurality of pieces of scene information, and that at least one of the pieces of scene information is permitted to be copied.

(6) Input/Output Unit 506

The input/output unit 506 reads information from an optical disk loaded in the copy apparatus 50, and outputs the read information to the list generation unit 502, the acquisition unit 507 and the detection unit 508.

In addition, the input/output unit 506 obtains information from the updating unit 509, and writes the obtained information to the loaded optical disk.

(7) Acquisition Unit 507

The acquisition unit 507 has a usage flag that is normally set to ON when the copy apparatus 50 is manufactured. Note that the usage flag may be set to OFF when the copy apparatus 50 is manufactured.

Only when the usage flag is ON, the obtaining unit 507 reads display-use copy control information from the optical disk via the input/output unit 506.

(8) Detection Unit 508

The detection unit 508 reads content data from the optical disk via the input/output unit 506, and judges whether embedded copy control information is embedded in the read content data.

When embedded copy control information is embedded, the detection unit 508 extracts the embedded copy control information from the content data in the optical disk, and outputs the extracted embedded copy control information.

(9) Updating Unit 509

The updating unit 509 updates the display-use copy control information recorded on the optical disk and the display-use control information stored in the list storage unit 503 as necessary.

It is necessary to update the display-use copy control information in the following instances.

(a) When the display-use copy control information recorded on the optical disk and the embedded copy control information embedded in the content data on the optical disk are not identical, and the copy restriction of the embedded copy control information is stricter than the copy restriction of the display-use copy control information.

(b) When the display-use copy control information stored in the list storage unit 503 and the embedded copy control information embedded in the content data on the optical disk are not identical, and the copy restriction shown by the embedded copy control information is stricter than the copy restriction shown by the display-use copy control information.

Furthermore, the updating unit 509 may also update the display-use copy control information when the display-use copy control information is “10” and the corresponding content data has been copied once by the copy apparatus 50. Here the updating unit 509 updates the display-use copy control information recorded on the optical disk and the display-use copy control information stored in the list storage unit 503 to “11”.

(10) Conversion Unit 510

The conversion unit 510 converts content data to a data format that is compatible with the semiconductor memory 71 to which the content data is to be copied. The conversion unit 510 includes a decrypter 511, a decoder 512, an encoder 513 and an encrypter 514.

The conversion unit 510 receives the embedded copy control information from the detection unit 508.

The decrypter 511 decrypts content data to generate decrypted content data.

The decoder 512 decodes the decrypted content data to generate decoded decrypted content data.

When the conversion unit 510 receives embedded copy control information from the detection unit 508, the conversion unit 510 embeds the received embedded copy control information in the decrypted content. Here, when the received embedded copy control information is “10”, the conversion unit 510 embeds embedded copy control information “11” instead of the embedded copy control information “10”.

The encoder 513 encodes the decoded decrypted content data to generate encoded decrypted content data.

The encrypter 514 encrypts the encoded decrypted content data to generate encrypted content data.

Note that the conversion unit 510 is not limited to embedding the received embedded copy control information in the generated decrypted content data. Instead, the encoder 513 may embed the embedded copy control information in the decoded decrypted content data during the encoding process. Alternatively, the encrypter 514 may embed the embedded copy control information in the encoded decrypted content data during the encrytping process.

(11) Copy Control Unit 515

When the usage flag in the acquisition unit 507 is ON and the content data does not include scene information, the copy control unit 515 executes copy processing (1) which is described below.

When the usage flag in the acquisition unit 507 is ON and the content data includes scene information, the copy control unit 515 executes scene copy processing (1).

When the usage flag in the acquisition unit 507 is OFF and the content data does not include scene information, the copy unit 515 executes copy processing (2).

When the usage flag in the acquisition unit 507 is OFF and the content data includes scene information, the copy unit 515 executes scene copy processing (2).

<Copy Processing (1)>

The copy control unit 515 reads the display-use copy control information corresponding to content data of which a specification has been received from the user, from the list storage unit 503.

Next, the copy control unit 515 judges whether the read display-use copy control information is either of “00” and “10”, or is “11”.

When the read display-use copy control information is “11”, the copy control unit 515 outputs a message showing that copying is not permitted to the display unit 505.

On the other hand, when the read display-use copy control information is either of “00” and “10”, the copy control unit 515 writes the read display-use copy control information to a display-use copy control information storage area 702 in the semiconductor memory 71. Here, when the read display-use copy control information is “10”, the copy control unit 515 changes the read display-use copy control information from “10” to “11”, and writes the display-use copy control information “11” to the display-use copy control information storage area 702.

Next, on detecting that the input/output unit 506 has finished reading one block of the content data stored on the optical disk, the copy control unit 515 writes other information to the semiconductor memory 71, and outputs a message showing that copying is complete to the display unit 505.

Furthermore, the copy control unit 515 writes the content data block to a content data storage area 703 in the semiconductor memory 71.

<Scene Copy Processing (1)>

The copy control unit 515 reads the representative display-use copy control information corresponding to the content data for which a specification has been received from the user, and the display-use copy control information corresponding to each scene, from the list storage unit 503.

Next, the copy control unit 515 judges whether the read representative display-use copy control information is either of “00” and “10”, or is “11”.

When the read representative display-use copy control information is “11”, the copy control unit 515 outputs a message showing that copying is not permitted to the display unit 505.

When the read display-use copy control information is either of “00” and “10”, the copy control unit 515 writes the read representative display-use copy control information and the read display-use copy control information corresponding to each scene to the display-use copy control information storage area 702 in the semiconductor memory 71. Here, when the read display-use copy control information is “10”, the copy control unit 515 changes the read display-use copy control information from “10” to “11”, and writes the display-use copy control information “11” to the display-use copy control information storage area 702.

Next, on detecting that the input/output unit 506 has finished reading one scene information block from the content data on the optical disk, the copy control unit 515 writes other information to the semiconductor memory 71, and outputs a message showing that copying is complete to the display unit 505.

The copy control unit 515 writes the block of content data to the content data storage area 703 in the semiconductor memory 71.

<Copy Processing (2)>

On detecting that the input/output unit 506 has finished reading one block of content data stored on the optical disk, the copy control unit 515 writes the embedded copy control information extracted by the detection unit 508 to the display-use copy control information storage area 702 in the semiconductor memory 71 as display-use copy control information. Here, when the read display-use copy control information is “10”, the copy control unit 515 changes the read display-use copy control information from “10” to “11”, and writes the display-use copy control information “11” to the display-use copy control information storage area 702. Next, the copy control unit 515 writes other information to the semiconductor memory 71, and outputs a message showing that copying is complete to the display unit 505.

The copy control unit 515 writes the block of data to the content data storage area 703 in the semiconductor memory 71.

<Scene Copy Processing (2)>

On detecting that the input/output unit 506 has finished reading one block of scene information from the content data on the optical disk, the copy control unit 515 writes the embedded copy control information extracted by the detection unit 508 to the display-use copy control information storage area 702 in the semiconductor memory 71 as display-use copy control information. Here, when the read display-use copy control information is “10”, the copy control unit 515 changes the read display-use copy control information from “10” to “11”, and writes the display-use copy control information “11” to the display-use copy control information storage area 702. Next, the copy control unit 515 writes other information to the semiconductor memory 71, and outputs a message showing that copying is complete to the display unit 505.

The copy control unit 515 writes the block of content data to the content data storage area 703 in the semiconductor memory 71.

(12) Key Input Unit 516

The key input unit 516 receives key input from the user of keys such as a playback key, a copy key, and specifications of content data, and outputs the received key input to the control unit 517.

Furthermore, the key input unit 516 prohibits key input, according to an instruction from the control unit 517. The key input unit 516 also removes the prohibition of key input, according to an instruction from the control unit 517.

Furthermore, the key input unit 516 does not accept specifications of content data corresponding to display-use copy control information that is recorded in the list storage unit 503 having a flag attached thereto showing that selection is not permitted.

(13) Control Unit 517

The control unit 517 controls other compositional elements of the copy apparatus 50. The operations of the control unit 517 are described in detail later.

(14) Output Unit 518

The output unit 518 receives content data that has been decrypted and decoded from the conversion unit 510, converts the received decrypted and decoded data to an analog image signal and an analog audio signal, and outputs the image signal and the audio signal to the monitor 51 and the speaker 52 respectively.

1.5 Semiconductor Memory 71

As shown in FIG. 7, the semiconductor memory 71 includes the writable index information storage area 701, display-use copy control information storage area 702 and content data storage area 703.

The index information storage area 701 includes an area for storing index information.

The display-use copy control information storage area 702 includes an area for storing pieces of display-use copy control information.

The content data storage area 703 includes an area for storing pieces of content data.

2. Operations of the Content Copy System 1

The following describes operations of the content copy system 1.

2.1 Operations by the Manufacturing Apparatus 20

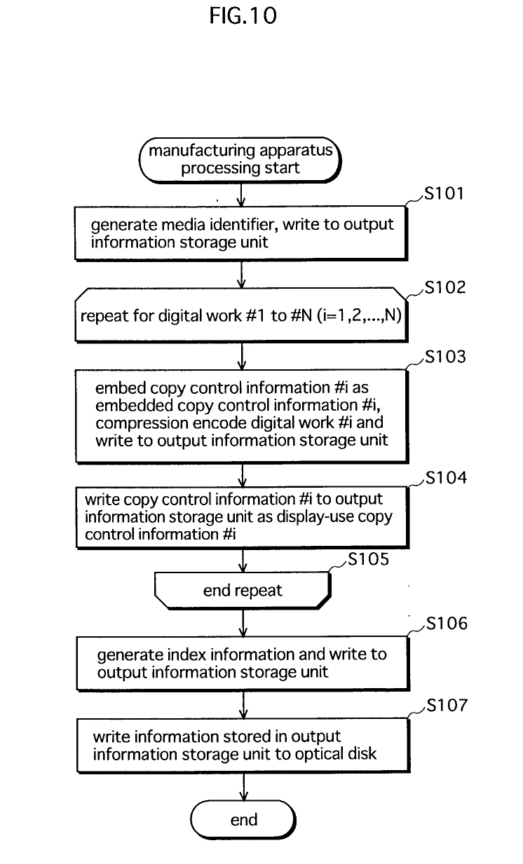

The following describes operations by the manufacturing apparatus 20, with use of the flowchart in FIG. 10.

The control unit 206 generates a media identifier for identifying an optical disk, and writes the read media identifier to the output information storage unit 204 (step S101).

Then, the control unit 206 repeats the following steps S103 to S104 for each digital work #i (i=1, 2, . . . , N) stored in the digital work storage unit 201.

The control unit 206 reads the copy control information #i that corresponds to the digital work #i from the control information storage unit 202. Under the control of the control unit 206, the compression encoding unit 203 embeds the read copy control information #i in the digital work #i as embedded copy control information #i, compression encodes the result, further encrypts the compression encoded digital work #i to generate content data #i, and writes the generated content data to the output information storage unit 204. In the case of the digital work #3, the compression encoding unit 203 embeds copy control information in each scene, and compression encodes the scene to generate a piece of scene information. The control unit 206 then writes content data that is composed of 99 pieces of scene information to the output information storage unit 204 (step S103).

Next, the control unit 206 writes the read copy control information #i to the output information storage unit 204 as display-use copy control information #i. Furthermore, the control unit 206 writes the pieces of scene copy control information to the output information storage unit 204 as pieces of display-use copy control information for the respective scenes (step S104).

Next, the control unit 206 generates index information for searching the content data on the optical disk, and writes the generated index information to the output information storage unit 204 (step S106).

Under the control of the control unit 206, the output unit 205 writes the media identifier, the index information, the seventeen pieces of display-use copy control information, the scene display-use copy control information and the seventeen pieces of content data written to the output information storage unit 204 to the unique ID storage area 101, the index information storage area 102, the display-use copy control information storage area 103 and the content data storage area 104 respectively in the optical disk 11 (step S107).

In this way the optical disk 11 to which the various types of information have been written is manufactured.

2.2 Operations by the Copy Apparatus 50

The following describes operations by the copy apparatus 50.

(1) Outline of Operations by the Copy Apparatus 50

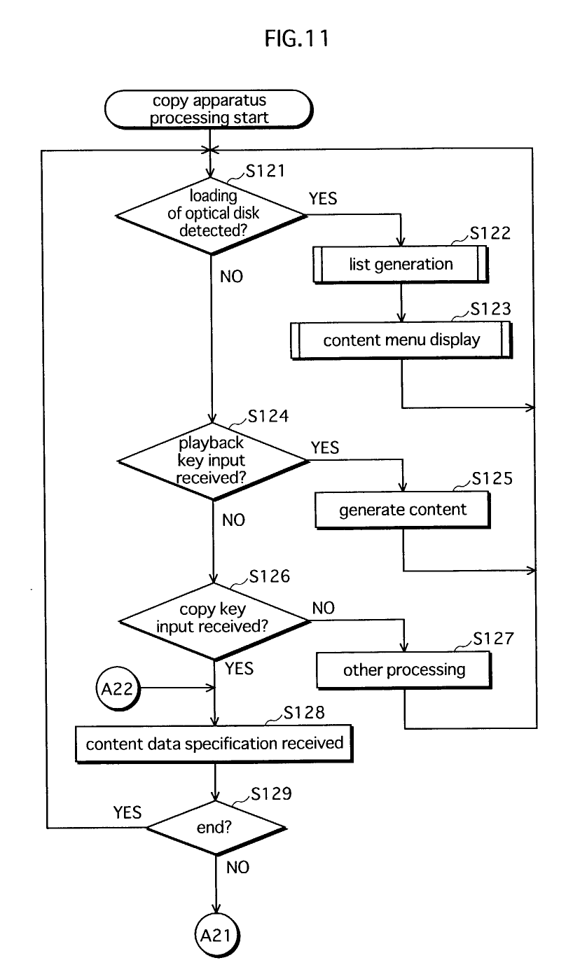

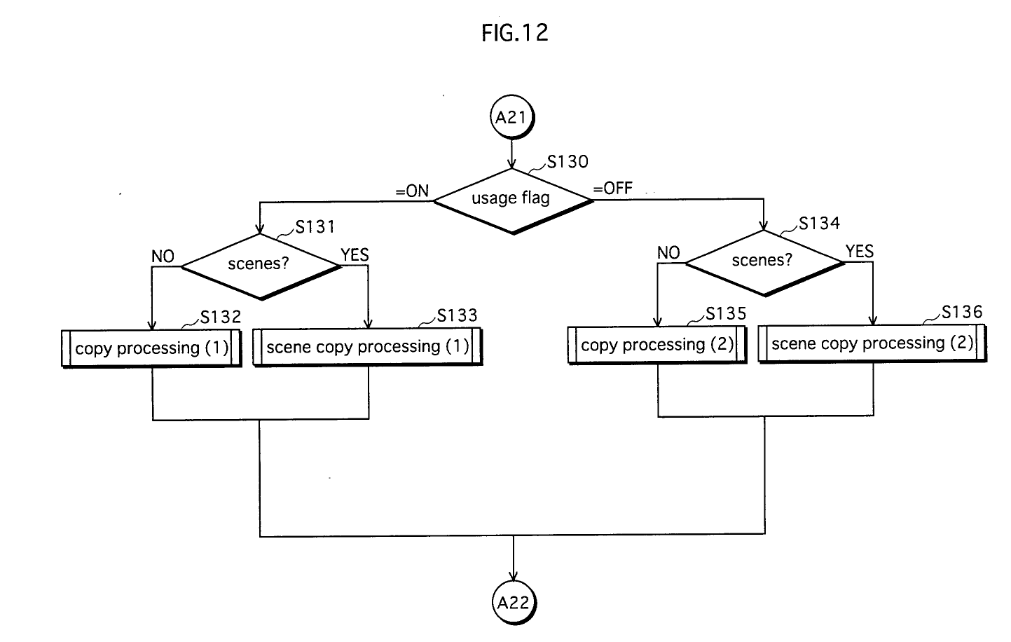

An outline of operations by the copy apparatus 50 is given with use of the flowcharts in FIGS. 11 to 12.

The input/output unit 506 detects whether an optical disk has been loaded in the copy apparatus 50, and on detecting that an optical disk has been loaded (step S121), the list generation unit 502 generates a list (step S122), and the menu generation unit 504 has a content menu displayed (step S123). The copy apparatus 50 then returns to step S121 to repeat the processing.

When the input/output unit 506 does not detect that an optical disk has been loaded (step S121), but instead the key input unit 516 receives an input of the playback key (step S124), the input/output unit 506 reads the content data specified by the user from amongst the content data recorded on the optical disk 12. Then, the decrypter 511 and the decoder 512 in the conversion unit 510 respectively decrypt and decode the read content data, and the output unit 518 converts the decrypted and decoded content data to an analog video signal and audio signal, which it outputs to the monitor 51 and the speaker 52 respectively (step S125). The copy apparatus 50 then returns to step S121 to repeat the processing.

When the input/output unit 506 does not detect that an optical disk has been loaded in the copy apparatus 50 (step S121), and the key input unit 516 does not receive an input of the playback key (step S124) but instead receives an input of a key other than the copy key (step S126), the copy apparatus 50 performs processing according to the key of which the input was received (step S127). The copy apparatus 50 then returns to step S121 to repeat the processing.

When the input/output unit 506 does not detect that an optical disk has been loaded in the copy apparatus 50 (step S121), and the key input unit 516 does not receive an input of the playback key (step S124) but instead receives an input of the copy key (step S126), the control unit 517 receives a specification of content data or a specification end, from the user via the key input unit 516 (step S128).

Here, on receiving the specification end from the user via the key input unit 516 (step S129), the control unit 517 considers the processing for copying the content data finished, and the copy apparatus 50 returns to step S121 to repeat the processing.

On the control unit 517 receiving a specification of content data from the user via the key input unit (step S129), the acquisition unit 507,judges whether the usage flag is ON or OFF, and when it judges that the usage flag is ON (step S130), and scene information is not included in the content data (step S131), copy processing (1) is executed (step S132). On the other hand, when scene information is included in the content data (step S131), scene copy processing (1) is executed (step S133). The copy apparatus 50 then returns to step S128 to repeat the processing.

When the acquisition unit 507 judges that the usage flag is OFF (step S130), and scene information is not included in the content data (step S134), copy processing (2) is executed (step S135). On the other hand, when scene information is included in the content data (step S134), scene copy processing (2) is executed (step S136). The copy apparatus 50 then returns to step S128 to repeat the processing.

(2) Operations for Generating a List

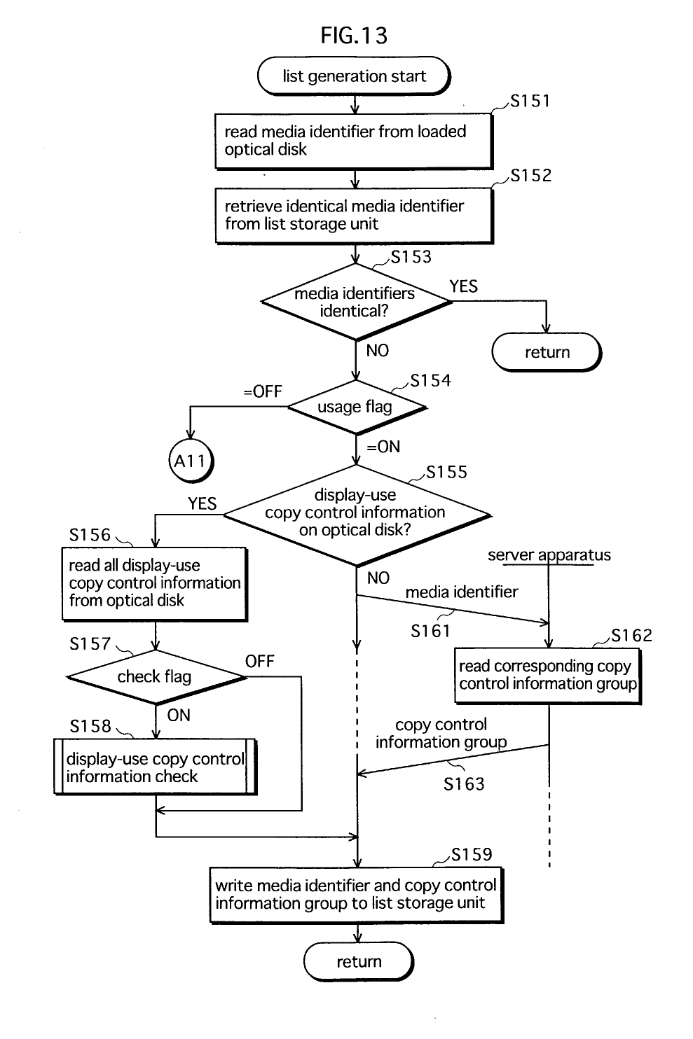

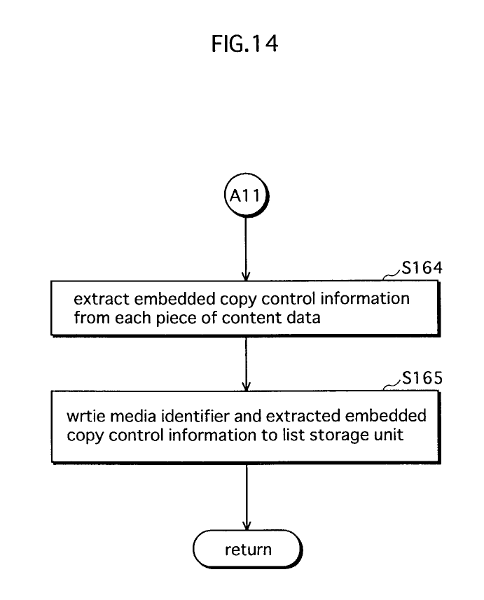

The following describes operations by the copy apparatus 50 for generating a list, with use of the flowcharts in FIGS. 13 and 14. Note that the operations for generating a list are the details of step S122 in the flowchart in FIG. 11.

The input/output unit 506 reads the media identifier from the loaded optical disk, outputs the read media identifier to the list generation unit 502, and the list generation unit 502 receives the media identifier (step S151).

Next, the list generation unit 502 searches the list storage unit 503 for an identical media identifier to the received media identifier (step S152), and when an identical media identifier exists (step S153), ends the processing.

When an identical media identifier does not exist (step S153), the acquisition unit 507 judges whether the usage flag is ON or OFF. When the usage flag is ON (step S154), the list generation unit 502 judges, via the input/output unit 506, whether display-use copy control information is recorded on the optical disk, and when display-use copy control information is recorded on the optical disk (step S155), the list generation unit 502 reads, via the input/output unit 506, all the display-use copy information from the loaded optical disk (step S156). Only when the check flag in the list generation unit 502 is ON (step S157), the list generation unit 502 checks the display-use copy control information (step S158). The list generation unit 502 then writes the read media identifier and a copy control information group composed of all the acquired copy control information in correspondence to the list storage unit 503 (step S159). The copy apparatus 50 then ends the processing.

The list generation unit 502 judges, via the input/output unit 506, whether display-use copy control information is recorded on the optical disk, and when display-use copy control information is not recorded on the optical disk (step S155), the list generation unit 502 transmits the read media identifier to the server apparatus 40 via the communication unit 501.and the Internet 80, and the control unit 403 of the server 40 receives the media identifier from the copy apparatus 50 via the Internet 80 and the communication unit 402 (step S161).

The control unit 403 of the server apparatus 40 reads the copy control information group that corresponds to the received media identifier from the copy control information table 411 in the information storage unit 401 (step S162), transmits the read copy control information group to the copy apparatus 50 via the communication unit 402 and the Internet 80, and the list generation unit 502 of the copy control apparatus 50 receives the copy control information group via the Internet 80 and the communication unit 501 (step S163). The copy apparatus 50 then moves to step S159.

The acquisition unit 507 judges whether the usage flag is ON or OFF, and when the usage flag is OFF (step S154), the detection unit 508 extracts, via the input/output unit 506, the embedded copy control information embedded in each piece of content data (step S164), and the list generation unit 502 writes the read media identifier and each piece of extracted embedded copy control information to the list storage unit 503 (step S165). The copy apparatus 50 then ends the processing.

(3) Operations for Checking Display-Use Copy Control Information

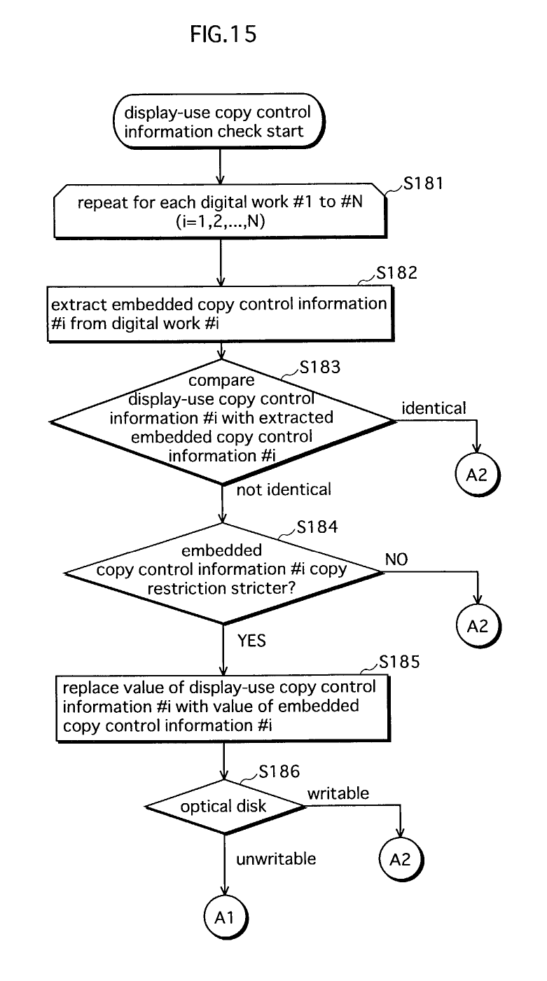

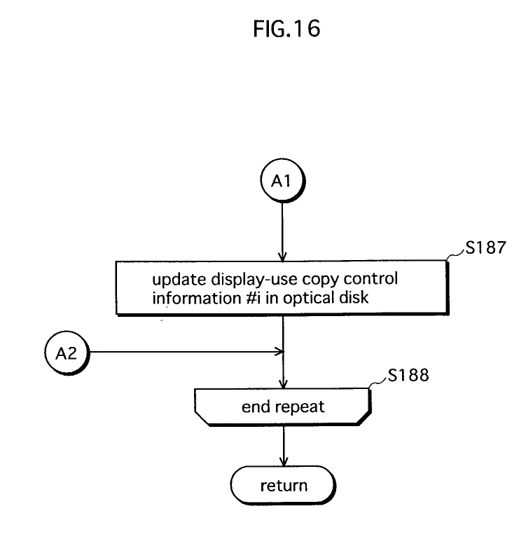

The following describes the operations by the list generation unit 502 of the copy apparatus 50 for checking display-use copy control information, with use of the flowcharts in FIGS. 15 and 16. Note that the operations for checking the display-use copy control information shown here are the details of step S158 in the flowchart in FIG. 13.

The list generation unit 502 repeats steps S182 to S187 for the digital work #i (i=1, 2, . . . , N).

The list generation unit 502 extracts embedded copy control information #i from the digital work #i recorded on the optical disk, via the input/output unit 506 and the detection unit 508 (step S182). Then, the list generation unit 502 compares the display-use copy control information #i recorded in the list storage unit 503 with the extracted embedded copy control information #i, and when the two pieces of information are identical (step S183), the list generation unit 502 proceeds to step S188.

When the display-use copy control information #i and the extracted embedded copy control information #i are not identical (step S183), the list generation unit 502 judges whether the copy restriction of embedded copy control information #i is stricter than that of the display-use copy control information #i, and when the judgement is positive (step S184), the list generation unit 502 replaces the value of the display-use copy control information #i recorded in the list storage unit 503 with the value of the embedded copy control information #i (step S185). Next, when the list generation unit 502 judges, via the input/output unit 506, that the loaded optical disk is writable (step S186), it replaces the value of the display-use copy control information #i recorded on the optical disk with the value of the embedded copy control information #i (step S187).

When the copy restriction of embedded copy control information #i is not stricter than that of the display-use copy control information #i (step S184), the list generation unit 502 proceeds to step S188.

(4) Operations for Displaying a Content Menu

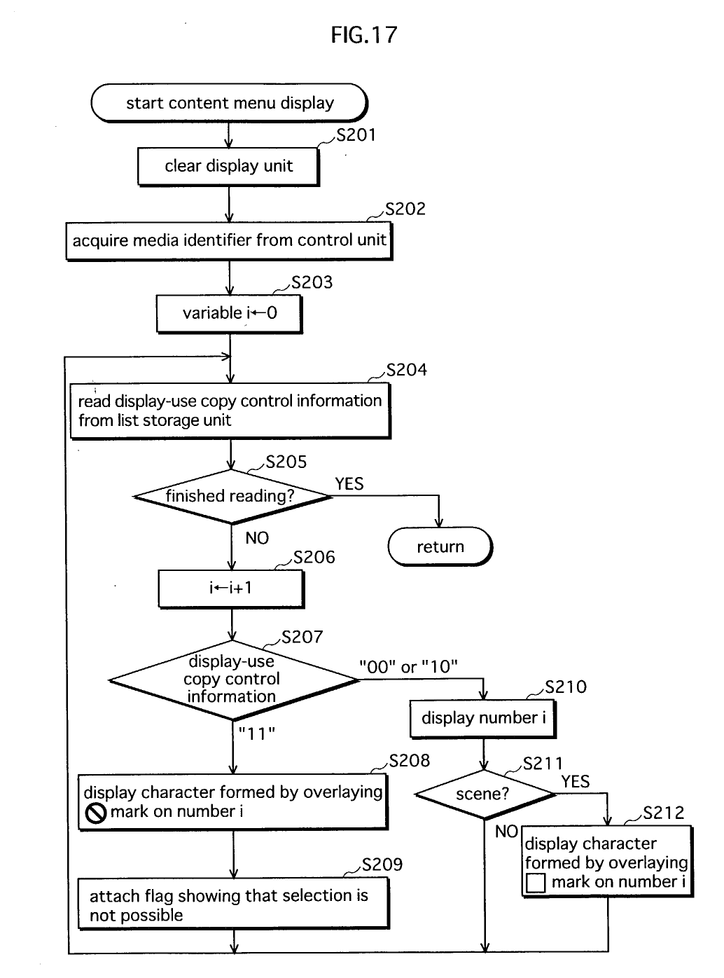

The following describes operations by the menu generation unit 504 and the display unit 505 of the copy apparatus 50 for displaying a content menu, with use of the flowchart in FIG. 17. Note that the operations shown here for displaying a content menu are the details of step S123 in the flowchart in FIG. 11.

The menu generation unit 504 clears the content displayed on the display unit 505 (step S201), acquires the media identifier of the optical disk whose content is to be displayed in the content menu from the control unit 517 (step S202), and sets the initial value of the variable i to “0” (step S203).

Next, the menu generation unit 504 tries to read in order the pieces of display-use copy control information from the list storage unit 503 (step S204). After detecting that it has read all the pieces of display-use copy control information (step S205), the menu generation unit 504 ends the processing.

On reading the display-use copy control information (step S205), the menu generation unit 504 adds “1” to the value of the variable i (step S206).

Next, the menu generation unit 504 judges whether the read display-use copy control information is either of “00” and “10”, or is “11”, and when the read display-use copy control information is “00” or “10” (step S207), outputs the number i to the display unit 505, and the display unit 505 displays the number i in the position shown by the variable i (step S210). Only when scene information is included in the content data corresponding to the read display-use copy control information (step S211), the menu generation unit 504 further outputs a scene mark to the display unit 505, and the display unit 505 displays the scene mark in the position shown by the variable i, overlaid on the number i (step S212). Next, the menu generation unit 504 returns to step S204 to repeat the processing.

On the other hand, when the menu generation unit 504 judges that the read display-use copy control information is “11” (step S207), it outputs a character composed of a copy prohibition mark overlaid on the number i to the display unit 505, and the display unit 505 displays the character in the position shown by the variable i (step S208). Furthermore, the menu generation unit 504 attaches and writes a flag showing the selection is not possible to the corresponding display-use copy control information stored in the list storage unit 503 (step S209). The menu generation unit 504 then returns to step S204 to repeat the processing.

(5) Operations for Copy Processing (1)

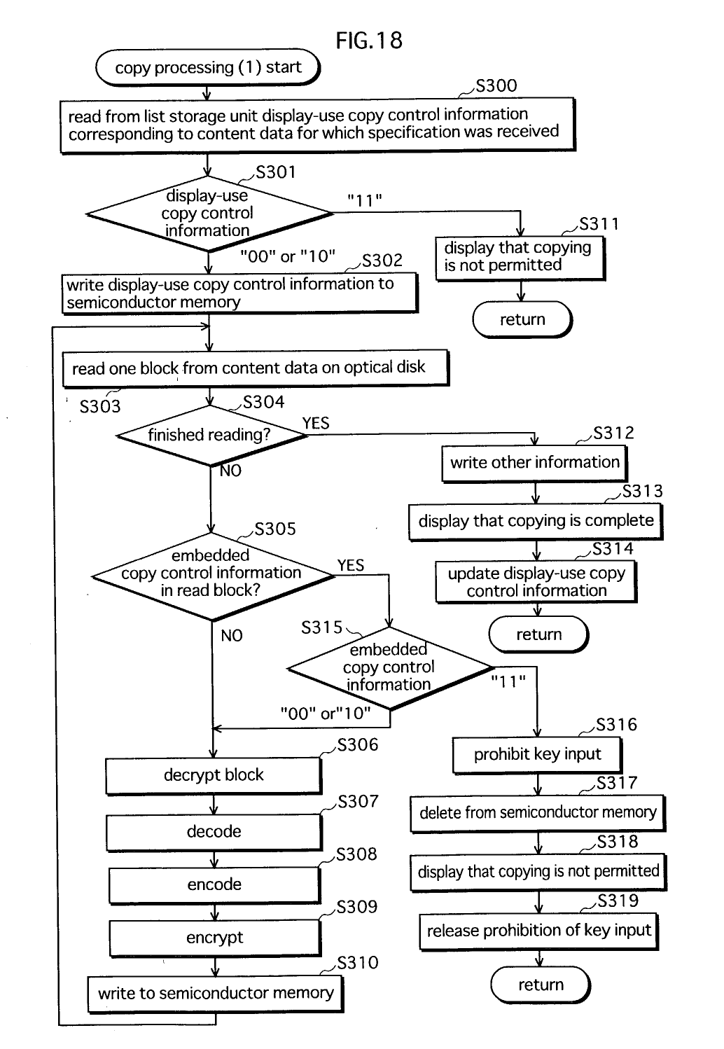

The following describes operations for content data copy processing (1) by the copy apparatus 50, with use of the flowchart in FIG. 18. Note that the operations shown here for content data copy processing (1) are the details of step S132 in the flowchart shown in FIG. 12.

The copy control unit 515 reads from the list storage unit 503 the display-use copy control information that corresponds to the content data for which a specification has been received from the user (step S300).

Next, the copy control unit 515 judges whether the read display-use copy control information is either of “00” and “10”, or is “11”, and when the read display-use copy control information is “11” (step S301), the copy control unit 515 outputs a message showing that copying is prohibited to the display unit 505, and the display unit 505 displays the message (step S311). The copy apparatus 50 then ends the processing.

On the other hand, when the copy control unit 515 judges that the read display-use copy control information is either of “00” and “10” (step S301), it writes the read display-use copy control information to the display-use copy control information area 702 in the semiconductor memory 71 (step S302).

Next, the input/output unit 506 tries to read one block of the content data from the loaded optical disk (step S303). On detecting that the input/output unit 506 has read the block (step S304), the copy control unit 515 writes other information to the semiconductor memory 71 (step S312), outputs a message showing that copying is complete to the display unit 505, and the display unit 505 displays the message (step S313). When it is necessary to update the display-use copy control information, the updating unit 509 updates the display-use copy control information stored on the optical disk and in the list storage unit 503 (step S314). The copy apparatus 50 then ends the processing.

When the input/output unit 506 has read the content data block from the loaded optical disk (step S304), the detection unit 508 judges whether there is embedded copy control information in the read block, and when there is embedded copy control information (step S305), the detection unit 508 judges whether the embedded copy control information is either of “00” and “10”, or is “11”, and when it is “11” (step S315), the control unit 517 prohibits key input of the key input unit 516 (step S316), deletes all information that has been written to the semiconductor memory 71 regarding the content data (step S317), and outputs a message showing that copying is prohibited to the display unit 505, which displays the message (step S318). Then the control unit 517 removes the prohibition of key input to the key input unit 516 (step S319). The copy apparatus 50 then ends the processing.

When the detection unit 508 judges that there is no embedded copy control information (step S305), or the detection unit 508 judges that the embedded copy control information is either of “00” and “10” (step S315) the decrypter 511 in the conversion unit 510 decrypts the block (step S306), the decoder 512 decodes the decrypted block (step S307), the encoder 513 encodes the decrypted decoded block (step S308), and the encrypter 514 encrypts the encoded block to generate a data block (step S309). Then, the copy control unit 515 writes the data block to the content data storage area 703 of the semiconductor memory 71 (step S310). The copy apparatus 50 then returns to step S303 to repeat the processing.

As has been described, when the copy apparatus 50 discovers part way through copying that a piece of embedded copy control information shows that copying is prohibited, the copy apparatus 50 deletes all the information that has already been written to the semiconductor memory 71 about the content data. Here, if input of a stop button of the copy apparatus 50 can be received from the user during the deletion processing, some of the content data that is being deleted from the semiconductor memory 71 will possibly be left in the semiconductor memory 71. This presents a problem in terms of copyright protection of the content data.

To solve this problem, when the copy apparatus 50 discovers part way through copying that a piece of embedded copy control information shows that copying is prohibited, reception of key input from the user is prohibited, and the prohibition of key input is removed when deleting is complete.

(6) Operations for Scene Copy Processing (1)

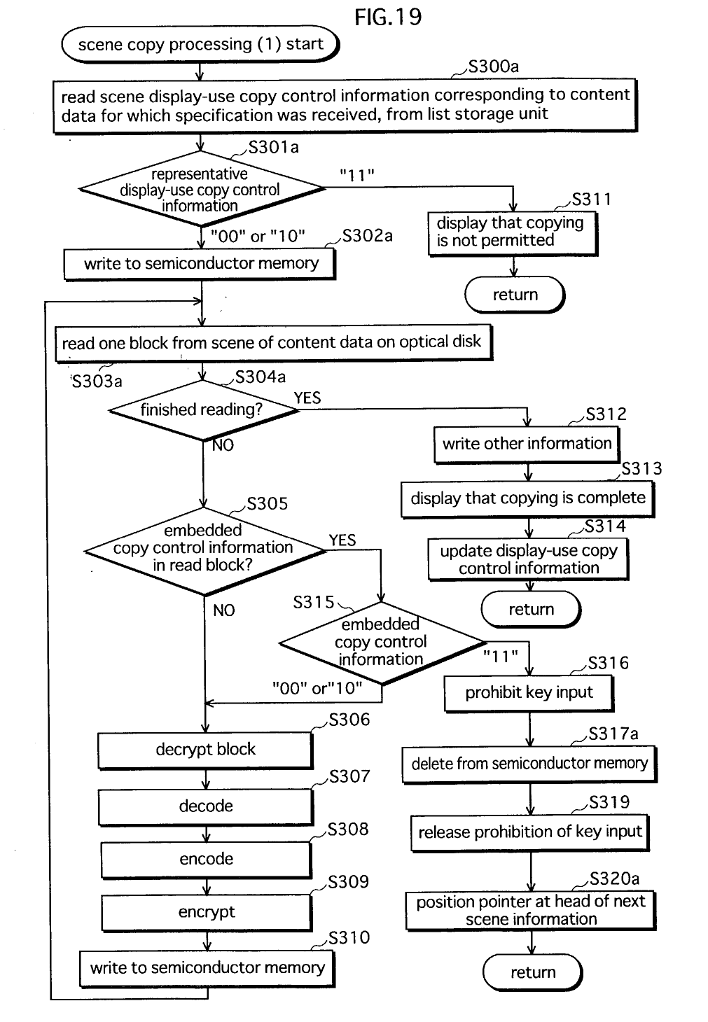

The following describes operations by the copy apparatus 50 for scene copy processing (1) for copying content data for each scene, with use of the flowchart in FIG. 19. Note that the operations for scene copy processing (1) are the details of the operations of step S133 in the flowchart in FIG. 12.

The copy control unit 515 reads from the list storage unit 503 the representative display-use copy control information corresponding to the content data for which a specification has been received from the user and the display-use copy control information corresponding to each scene (step S300a).

Next, the copy control unit 515 judges whether the read representative display-use copy control information is either of “00” and “10”, or is “11”, and if the representative display-use copy control information is “11” (step S301a), outputs a message showing that copying is prohibited to the display unit 505, which displays the message (step S311). The copy apparatus 50 then ends the processing.

On the other hand, if the read representative display-use copy control information is either of “00” and “10” (step S301a),the copy control unit 515 writes the read representative display-use copy control information and the display-use copy control information corresponding to each scene to the display-use copy control information storage area 702 in the semiconductor memory 71 (step S302a).

Next, the input/output unit 506 tries to read one block from the scene information of the content data on the optical disk (step S303a). On detecting that the input/output unit 506 has finished reading the block (step S304a), the copy control unit 515 writes other information to the semiconductor memory 71 (step S312), and outputs a message showing that copying is complete to the display unit 505, which displays the message (step S313). When it is necessary to update the display-use copy control information, the updating unit 509 updates the display-use copy control information recorded on the optical disk and in the list storage unit 503 (step S314). The copy apparatus 50 then ends the processing.

When the input/output unit 506 has read one block of the scene information from the content data on the loaded optical disk (step S304a), the detection unit 508 judges whether there is embedded copy control information in the read block, and when there is embedded copy control information in the read block (step S305), the detection unit 508 judges whether the embedded copy control information is either of “00” and “10”, or is “11”, and when the embedded copy control information is “11” (step S315), the control unit 517 prohibits reception of key input to the key input unit 516 (step S316) and deletes all the information that has been written to the semiconductor memory 71 regarding the scene information (step S317a). The control unit 517 then removes the prohibition of key input by the key input unit 516 (step S319), and positions a pointer for reading at the head of the next piece of scene information (step S320a) Then copy apparatus then return to step S303a to repeat the processing.

When the detection unit 508 judges that there is no embedded copy control information (step S305), or that the embedded copy control information is either of “00” and “10” (step S315), the decrypter 511 in the conversion unit 510 decrypts the block (step S306), the decoder 512 decodes the decrypted block (step S307), the encoder 513 encodes the decrypted decoded block (step S308), and the encrypter 514 encrypts the encoded block, to generate block data (step S309). The copy control unit 515 writes the block data to the content data storage area 703 of the semiconductor memory 71 (step S310). The copy apparatus 50 then returns to step S303a to repeat the processing.

(7) Operations for Copy Processing (2)

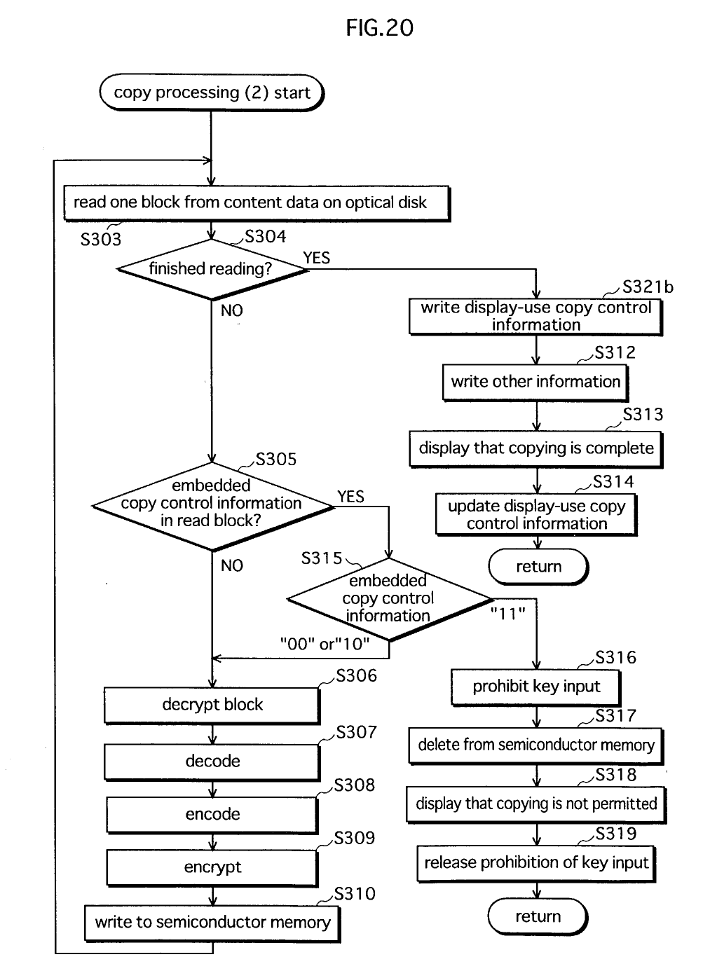

The following describes operations by the copy apparatus 50 for content data copy processing (2), with use of the flowchart in FIG. 20. Note that operations shown here for content data copy processing (2) are details of step S135 in the flowchart in FIG. 12.

The input/output unit 506 tries to read one block of the content data from the loaded optical disk (step S303). On detecting that the input/output unit 506 has finished reading the block (step S304), the copy control unit 515 writes the embedded copy control information to the display-use copy control information storage area 702 in the semiconductor memory 71 as display-use copy control information (step S321b), and writes other information to the semiconductor memory 71 (step S312). The copy control unit 515 outputs a message showing that copying is complete to the display unit 505, which displays the message (step S313). When it is necessary to update the display-use copy control information, the updating unit 509 updates the display-use copy control information stored on the optical disk and in the list storage unit 503 (step S314). The copy apparatus 50 then ends the processing.

When the input/output unit 506 has read one block of content data from the loaded optical disk (step S304), the detection unit 508 judges whether there is embedded copy control information in the read block, and when there is embedded copy control information in the read block (step S305), the detection unit 508 judges whether the embedded copy control information is either of “00” and “10”, or is “11”, and when the embedded copy control information is “11” (step S315), the control unit 517 prohibits reception of key input by the key input unit 516 (step S316). Next, the control unit 517 deletes all the information that has been written to the semiconductor memory 71 regarding the content data (step S317), and outputs a message showing that copying is not permitted to the display unit 505, which displays the message (step S318). The control unit 517 then removes the prohibition of key input by the key input unit 516 (step S319). The copy apparatus 50 then ends the processing.

When the detection unit 508 judges that there is no embedded copy control information (step S305), or that the embedded copy control information is either of “00” and “10” (step S315), the decrypter 511 in the conversion unit 510 decrypts the block (step S306), the decoder 512 decodes the decrypted block (step S307), the encoder 513 encodes the decrypted decoded block (step S308), and the encrypter 514 encrypts the encoded block, to generate a data block (step S309). The copy control unit 515 writes the data block to the content data storage area 703 of the semiconductor memory 71 (step S310). The copy apparatus 50 then returns to step S303 to repeat the processing.

(8) Operations for Scene Copy Processing (2)

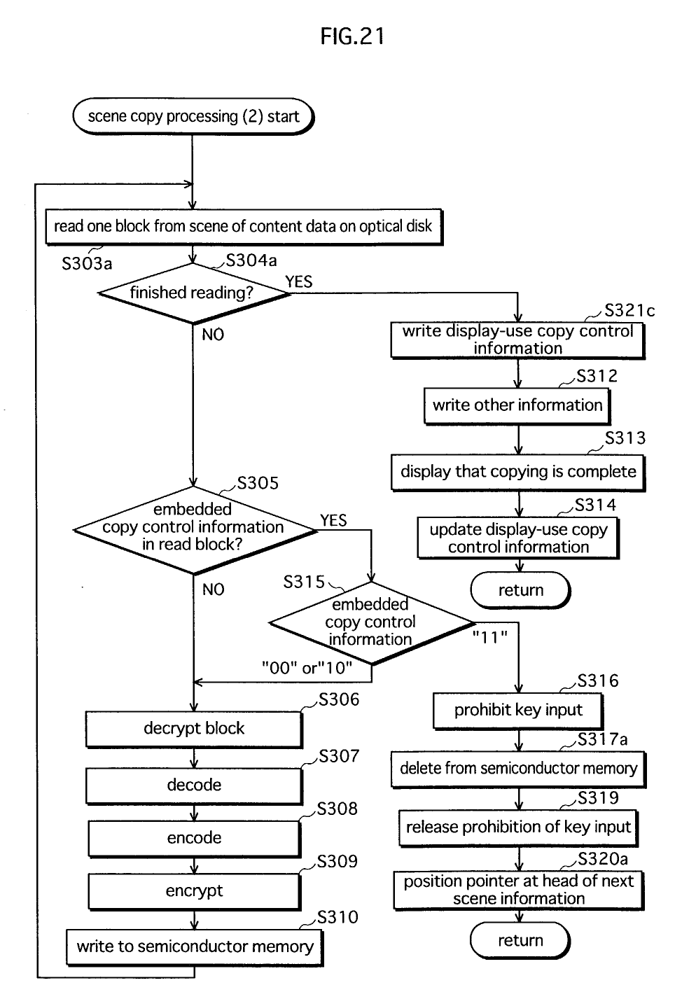

The following describes operations by the copy apparatus 50 for scene copy processing (2) for copying content data for each scene, with use of the flowchart in FIG. 21. Note that the operations for scene copy processing (2) are the details of the operations of step S136 in the flowchart in FIG. 12.

The input/output unit 506 tries to read one block from the scene information of the content data on the optical disk (step S303a). On detecting that the input/output unit 506 has finished reading the block (step S304a), the copy control unit 515 writes the embedded copy control information to the display-use copy control information storage area 702 of the semiconductor memory 71 as display-use copy control information (step S321c). Next, the copy control unit 515 writes other information to the semiconductor memory 71 (step S312), and outputs a message showing that copying is complete to the display unit 505, which displays the message (step S313). When it is necessary to update the display-use copy control information, the updating unit 509 updates the display-use copy control information recorded on the optical disk and in the list storage unit 503 (step S314). The copy apparatus 50 then ends the processing.

When the input/output unit 506 has read one block from the scene information of the content data on the loaded optical disk (step S304a), the detection unit 508 judges whether there is embedded copy control information in the read block, and when there is embedded copy control information in the read block (step S305), the detection unit 508 judges whether the embedded copy control information is either of “00” and “10”, or is “11”, and when the embedded copy control information is “11” (step S315), the control unit 517 prohibits reception of key input by the key input unit 516 (step S316) and deletes all the information that has been written to the semiconductor memory 71 regarding the scene information (step S317a). The control unit 517 then removes the prohibition of key input by the key input unit 516 (step S319), and positions the pointer for reading at the head of the next piece of scene information (step S320a). The copy apparatus 50 then return to step S303a to repeat the processing.

When the detection unit 508 judges that there is no embedded copy control information (step S305), or that the embedded copy control information is either of “00” and “10” (step S315), the decrypter 511 of the conversion unit 510 decrypts the block (step S306), the decoder 512 decodes the decrypted block (step S307), the encoder 513 encodes the decrypted decoded block (step S308), and the encrypter 514 encrypts the encoded block, to generate a data block (step S309). The copy control unit 515 writes the data block to the content data storage area 703 of the semiconductor memory 71 (step S310). The copy apparatus 50 then returns to step S303a to repeat the processing.

3. Modifications

Note that the present invention is not limited to the above-described embodiment. Cases such as the following are included in the present invention:

(1) List generation and content menu display are not limited to taking place when an optical disk is loaded in the copy apparatus as described in the embodiments.

A list may be generated when the playback key is operated by the user, or when the copy key is operated by the user.

Furthermore, a list may be generated and a content menu displayed when the playback key is operated by the user, or when the copy key is operated by the user.

Furthermore, a list generation key may be provided for generating a list, and the list generated when this list generation key is operated by the user.

Furthermore, a content menu display key for displaying a content menu may be provided, and a content menu displayed when the content menu display key is operated by the user.

(2) In the embodiments, a content menu is generated and then displayed after a list has been generated, with use of the display-use copy control information recorded in the list. However it is possible for the copy apparatus not to create a list, but instead, when an optical disk is loaded in the copy apparatus, to read the display-use copy control information from the optical disk, and display the content menu with use of the read display-use copy control information.

(3) It is not necessary for the copy apparatus to have the conversion unit described in the embodiment. If the copy apparatus does not have a conversion unit, the content data recorded on the optical disk are digital works that have not been encrypted or encoded.

Furthermore, the conversion unit may include only a decrypter and an encrypter. In this case, the content data recorded on the optical disk are digital works that have only been encrypted.

Furthermore, the conversion unit may include only a decoder and an encoder. In this case, the content data recorded on the optical disk are digital works that have only been encoded.

Furthermore, the conversion unit may include any arbitrary combination of a decrypter, a decoder, an encoder and an encrypter. For example, in a case in which the content data on the original optical disk is recorded un-encrypted and un-compressed, and copied to a semiconductor memory encrypted and encoded, the conversion unit need include only an encoder and an encrypter.

(4) It is not necessary for the copy apparatus to have the communication unit described in the embodiment. In this case, the copy apparatus may use embedded copy control information as display-use copy control information by extracting the embedded copy control information embedded in the content data recorded on the optical disk if display-use copy control information is not recorded on the optical disk.

(5) The copy control information used is not limited in the sense shown in FIG. 5 and described in the embodiment.

The copy control information may include, for example, a maximum amount of times that content data may be copied.

Furthermore, the copy control information may limit the type of semiconductor memory to which the content data may be copied.

(6) The recording medium to which content data is copied is not limited to being the semiconductor memory described in the embodiment, but instead may be, for example, a readable/writable optical disk.

(7) It is not necessary for the optical disk in the embodiment to have display-use copy control information pre-recorded thereon. In this case, the copy apparatus may further include a copy control information detection unit that detects embedded copy control information in the content data recorded on the optical disk; a copy control information list creation unit that creates a list of the embedded copy control information detected by the copy control information detection unit; a copy control information list storage unit that stores the copy control information list; and a copy control information display unit that displays and notifies the user of copy control information before the content data is copied.

The copy control information list creation unit may create the copy control information list during playback or during copying of the content data on the optical disk. Furthermore, the copy control information creation unit may have a communication sub-unit that communicates with an external network, and may create the copy control information list by obtaining the copy control information of the content data from the external network.

(8) The content data may be music data, video data, character data, a computer program, spreadsheet data, a data base, graphic data, or any other data, or a combination of these types of data. The content data may be encrypted.

In the case of music data, the format of the music data may be MP3 (MPEG 1 Audio Layer 3), or any other music data format such as LPCM (Liner Pulse Code Modulation) and AAC (Advanced Audio Coding).

(9) As described in the embodiment, copy control information (copy control information #1, copy control information #2, . . . , copy control information #N) is included in each piece of content data recorded on the optical disk. In the embodiment, the copy control information, each piece of which is a two bit value shown in FIG. 5, is embedded in the content data with use of a watermark technique. The size and meaning of the pieces of copy control information are not limited to those shown in FIG. 5, and instead, anything that expresses a copy rule is acceptable.

Furthermore, the copy control information may be embedded in the content data with use of a technique other than a watermark technique. Furthermore, the copy control information may be encrypted and then embedded.

Furthermore, although in the embodiments content data may be copied freely when it does not have copy control information embedded therein, it is possible to have content data in which no copy control information is embedded copyable only once, or treated in another way.

(10) In the embodiment, the list generation unit 502 judges whether the copy restriction in the embedded copy control information #i is stricter than the copy restriction in the display-use copy control information #i; and when the copy restriction in the embedded copy control information #i is stricter than that in the display-use copy control information #i, replaces the value of the display-use copy control information #i with the value of the embedded copy control information #i. This enables correction of inconsistencies in the embedded copy control information in the content data on the optical disk, and the display-use copy control information corresponding to the content data on the optical disk, and potentially lessens confusion for the user.

Here, the less strict restriction is replaced with the stricter restriction, but is not limited to being so. Any rule by which one value is selected from amongst a plurality of possible values of the copy control information is possible.

(11) The recording medium loaded in the copy apparatus for input for copying in the embodiment is not limited to being an optical disk. Any writable recording medium in which display-use copy control information is updateable, such as a semiconductor memory, is possible.

Furthermore, if the display-use copy control information is not updated, the recording medium loaded in the copy apparatus for input may be any read-only recording medium such as a CD or a DVD-ROM (digital versatile disk read only memory). Furthermore, any existing recording medium, such as an optical disk (for example, a DVD), or a semiconductor memory, a hard disk or the like is possible as long as it is able to have content data recorded thereon.

(12) The copy apparatus is not limited to being the audio recording/playback apparatus described as a specific example, but may be any copy apparatus that is capable of copying content data.

(13) The recording medium to which content data is copied is not limited to being the described semiconductor memory, but may be any type of writable recording medium such as a DVD-RAM (digital versatile disk random access memory).

(14) The copy apparatus may have a function of not only detecting copy control information embedded in content data, but also rewriting the content of the copy control information embedded in the content data.

(15) The following is a possible structure of the invention. The optical disk loaded in the copy apparatus for input may include two media identifiers 111a and 111b in the unique key ID storage area 101.

Here, the media identifier 111a is a manufacturing serial number unique to the optical disk. The media identifier 111b is a set of the ISRC codes of the pieces of content data stored in a content data storage area 104.

The list generation unit 502 of the copy apparatus 50 generates, with use of the media identifier 111a, a list of the media identifier 111a and the copy control information of each piece of content data.

The server apparatus 40 stores a media identifier, which is the set of ISRC codes of each piece of content data, and the copy control information group in correspondence.

If display-use copy control information is not recorded on the optical disk, the copy apparatus 50 reads the media identifier 111b from the optical disk, and transmits the read media identifier 111b to the server 40.

The server 40 reads the copy control information group that corresponds to received media identifier, from within itself, and transmits the read copy control information group to the copy apparatus 50.

The copy apparatus 50 generates a list composed of the received copy control information group and the media identifier 111a, and writes the generated list to the list storage unit 503.

(16) The list generation unit 502 may be provided in advance with a creation flag showing whether to perform processing to create a copy control information list. This creation flag is ordinarily set to ON when the copy apparatus 50 is manufactured. Note that it is also possible for the creation flag to be set to OFF when the copy apparatus 50 is manufactured.

The list generation unit 502 generates a list and writes the list to the list storage unit 503 only when the creation flag is ON.

The key input unit 516 may receive input of a list creation OFF key or a list creation ON key from the user. The list creation OFF key shows an operation to change the creation flag from ON to OFF, and list creation ON key shows an operation to change the creation flag from OFF to ON.

On receiving an input of the list creation OFF key or the list creation ON key, the key input unit 516 outputs instruction information based on the received input to the control unit 517, the control unit 517 receives the instruction information, and changes the creation flag in the list generation unit 502 based on the received instruction information. In other words, on receiving instruction information corresponding to the list creation OFF key the control unit 517 switches the creation flag from ON to OFF, and on receiving instruction information corresponding to the list creation ON key the control unit 517 switches the creation flag from OFF to ON, respectively.

Furthermore, when the copy apparatus 50 is in a pause state at the point at which the creation flag is switched to ON, the copy apparatus may automatically transition to a playback state, and commence playing back the content data. Furthermore, the sound may be muted when content data is automatically played back.

(17) It is not necessary to provide the acquisition unit 507 with a usage flag. When the acquisition unit 507 does not have a usage flag, the acquisition unit 507 operates in the same way as when the usage flag is ON.

(18) It is not necessary to provide the list generation unit 502 with a check flag. When the list generation unit 502 does not have a check flag, it may be structured to operate in the same way as when the check flag is ON, or conversely, it may be constructed to operate in the same way as when the check flag is OFF.

(19) When the content data includes a plurality of pieces of scene information, the menu generation unit 504 may display numbers that correspond to the pieces of scene information, and display a mark overlaid on each number to show whether the scene information is freely copyable, copyable only once, or not copyable, based on the pieces of scene information.

(20) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, a CD-ROM (compact disk-read only memory), and MO (magneto-optical), a DVD-ROM, a DVD RAM, a BD (BluRay Disc) or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(21) The present invention may be any combination of the above-described embodiments and modifications.

4. Conclusion

As has been described, the present invention is a recording medium that has a first area and a second area, and that has at least one piece of digital data, at least one piece of first copy control information and at least one piece of second copy control information relating to the piece of digital data recorded thereon, wherein the first area includes the piece of digital data and the first copy control information which is embedded in the piece of digital data, and the second area includes the second copy control information whose content is identical to the first copy control information.

Here, the first copy control information may be embedded in the pieces of digital data according to a watermark technique.

Furthermore, the present invention is a copy apparatus that copies the pieces of digital data recorded on the recording medium, the copy apparatus including: a second copy control information acquisition unit that reads the second copy control information from the recording medium; and a copy control information display unit for displaying and notifying the user of the first copy information, based on the second copy control information, when copying each piece of digital data.

Here, when the second copy control information included in the recording medium differs from the first control information embedded in the piece of digital content, the copy apparatus may update the second copy control information.

Here, the second copy control information acquisition unit may further include a communication sub-unit that communicates with an external network, and acquire the second copy control information of the digital data from the external network.

Furthermore, the present invention is a copy apparatus that copies digital data recorded on a recording medium, including: a copy control information detection unit that detects copy control information that is embedded in at least one piece of digital data included in the recording medium; a copy control information list creation unit that creates a list of the copy control information detected by the copy control information detection unit; a copy control information list storage unit that stores the copy control information list; and a copy control information display unit for displaying and notifying the user of the first copy information, based on the second copy control information, when copying the pieces of digital data.

Here, the copy control information list creation unit may create a copy control information list during playback or during copying of the digital content included in the recording medium.

Here, the copy control information list creation unit may have a communication sub-unit that communicates with the external network, and acquire the copy control information of the digital data from the external network.

Here, the present invention may be a copy apparatus that copies digital data that is recorded on a recording medium, including: a copy control information detection unit that detects copy control information that is embedded in at least one piece of digital data included in the recording medium; and a key input control unit that controls key input from a user, based on the copy control information detected by the copy control information detection unit.

5. Effects of the Invention

As described, the present invention makes it possible to inform the user in advance of copy control information about each piece of content data when copying content data, and avoid user confusion when copying.

The present invention is a recording medium having information recorded thereon, the information including: a digital work in which first copy information showing a restriction relating to copying the digital work is embedded; and second copy information showing a restriction relating to copying the digital work.

According to the stated structure, second copy information, which shows a restriction relating to copying the digital work, is recorded on the recording medium. Therefore a copy apparatus that copies the digital work from the recording medium reads the second copy information rather than reading the first copy information embedded in the digital work, and uses the second copy information to generate and display display information showing the restriction. This reduces the time required to judge whether the digital work is permitted to be copied or not, compared to when the embedded copy information is extracted from the digital work.

Here, the first copy information may be embedded in the digital work with use of a watermark technique.

According to the stated structure, the first copy information is embedded in the digital work with use of a watermark technique. Therefore it is difficult for a third party to tamper illegally with the first copy information.

Furthermore, the present invention is a copy apparatus that reads a digital work from a recording medium and copies the read digital work, the digital work having embedded therein first copy information showing a restriction relating to copying the digital work, the copy apparatus including: an acquisition unit operable to acquire second copy information that shows a restriction relating to copying the digital work; and a display unit operable to generate, based on the acquired second copy information, display-use copy information expressing the restriction shown by the second copy information, and display the generated display-use copy information.

According to the stated structure, the copy apparatus acquires the second copy information showing a restriction relating to copying the digital work recorded on the recording medium rather than reading the first copy information embedded in the digital work, and uses the second copy information to generate and display display information showing the restriction. This reduces the time required to judge whether the digital work is permitted to be copied or not, compared to when the embedded copy information is extracted from the digital work.

Here, the second copy information may be recorded on the recording medium, and the acquiring unit may acquire the second copy information by reading the second copy information from the recording medium.

According to the stated structure, the recording medium further has second copy information recorded thereon, and the acquisition unit acquires the second copy information by reading the second copy information from the recording medium. Therefore the second copy information can be obtained quickly compared to when embedded copy information is extracted from a digital work.

Here, the recording medium may be rewritable, and the copy apparatus may further include: an extraction unit operable to extract the first copy information from the digital work; a judgement unit operable to compare the acquired second copy information and the extracted first copy information, and judge whether the restriction shown by the first copy information is stricter than the restriction shown by the second copy information; and an update unit operable to, when the judgement unit judges that the restriction shown by the first copy information is stricter than the restriction shown by the second copy information, replace the second copy information with the first copy information.

According to the stated structure, the copy apparatus compares the acquired second copy information and the first copy information extracted from the digital work, and when the restriction shown by the first copy information is stricter than that shown by the second copy information, writes the extracted first information in place of the second copy information recorded on the recording medium. Therefore, even if the first copy information and the second copy information do not match, the second copy information can be updated so that copying of the digital work is controlled correctly.

Here, the copy apparatus may be connected to a server apparatus via a network, and the server apparatus may store the second copy information in correspondence with the digital work, wherein the acquisition unit acquires the second copy information from the server apparatus via the network.

According to the stated structure, the copy apparatus acquires the second information via the network from the server apparatus. Therefore the second copy information can be obtained quickly compared to when embedded copy information is extracted from a digital work.

Here, the copy apparatus of Claim may be connected to a server apparatus via a network, and the server apparatus may store the second copy information in correspondence with the digital work, wherein the acquisition unit includes: a judgement sub-unit operable to judge whether the second copy information is recorded on the recording medium or not; a first acquisition sub-unit operable to, when the judgement sub-unit judges that the second copy information is recorded on the recording medium, acquire the second copy information by reading the second copy information from the recording medium; and a second acquisition operable to, when the judgement sub-unit judges that the second copy information is not recorded on the recording medium, acquire the second copy information from the server apparatus via the network.

According to the stated structure, the recording medium further has second copy information recorded thereon, and the acquisition unit acquires the second copy information by reading the second copy information from the recording medium, or the copy apparatus acquires the second copy information via the network from the server. Therefore the second copy information can be obtained quickly compared to when embedded copy information is extracted from a digital work.

Here, the copy apparatus may further include: a storage unit operable to include an area for storing information; and a writing unit operable to write the acquired second copy information to the storage unit in correspondence with the digital work.

According to the stated structure, the copy apparatus stores the acquired second copy information in correspondence with the digital work. Therefore when the digital work is played back or copied, the stored second copy information can be used, without having to newly acquire the second copy information.

Here, the copy apparatus may further include: a copy judgement unit operable to judge, with use of the second copy information stored by the storage unit, whether copying of the digital work is permitted or not, wherein the copy apparatus copies the digital work only when copying is permitted.

According to the stated structure, the copy apparatus can judge whether copying of the digital work is permitted by using the stored second copy information without having to newly acquire the second copy information.

Here, the copy apparatus may further include: an extraction unit operable to extract the first copy information from the digital work; a judgement unit operable to compare the acquired second copy information and the extracted first copy information, and judge whether the restriction shown by the first copy information is stricter than the restriction shown by the second copy information; and an update unit operable to, when the judgement unit judges that the restriction shown by the first copy information is stricter than the restriction shown by the second copy information, replace the second copy information with the first copy information.

According to the stated structure, the copy apparatus compares the acquired second copy information and the first copy information extracted from the digital work, and when the restriction shown by the first copy information is stricter than that shown by the second copy information, writes the extracted first information in place of the second copy information stored by the copy apparatus. Therefore, even if the first copy information and the second copy information do not match, the second copy information can be updated so that copying of the digital work is controlled correctly.

Here, the copy apparatus may further include: an input reception unit operable to receive input from a user; and a reception restriction unit operable to, when during copying of the digital work the first copy information is detected to show that copying is prohibited, control the input reception unit so that input from the user is prohibited while a copy that has already been made of part of the digital work is being deleted.

According to the stated structure, even when the copy apparatus detects during copying that a piece of the first copy information embedded in the digital work shows that copying is prohibited, the copy apparatus prohibits user input while deleting the copy of the part of the information of the digital work that has already been made. Therefore input of the stop button is not received from the user, and none of the copy of the information of the digital work is left on the recording medium.

Here, the digital work may be composed of a predetermined number of information blocks; the first copy information may be composed of a predetermined number of pieces of first block copy information that correspond, respectively, to the predetermined number of information blocks, each of the predetermined number of pieces of the first block copy information being embedded in a corresponding one of the predetermined number of information blocks and showing a restriction relating to copying the corresponding one of the predetermined number of information blocks; the second copy information may be composed of a predetermined number of pieces of second block copy information that correspond, respectively, to the predetermined number information blocks, and the display unit may generate the display-use copy information based on the second copy information that is composed of the predetermined number of pieces of second block copy information.

According to the stated structure, even when the digital work is composed of a plurality of blocks of information, the display-use copy information is generated based on the second block copy information set in each block of information. This reduces the time required to judge whether the digital work is permitted to be copied or not, compared to when the embedded copy information is extracted from the digital work.

Although the present invention has been fully described by way of various examples with reference to the accompanying drawings, it is to be noted that various changes and modifications will be apparent to those skilled in the art. Therefore, unless such changes and modifications depart from the scope of the present invention, they should be construed as being included therein.

Industrial Applicability

The present invention can be used in a copy apparatus that copies content data recorded on a recording medium to another recording medium, and in the recording media. The present invention is particularly suitable for cases in which the content data is digital data whose copyright is protected with use of a watermark technique.

What is claimed is:

1. A recording medium having information recorded thereon, the information comprising:
a digital work in which first copy information showing a restriction relating to copying the digital work is embedded; and
second copy information showing a restriction relating to copying the digital work.

2. The recording medium of claim 1, wherein
the first copy information is embedded in the digital work with use of a watermark technique.

3. A copy apparatus that reads a digital work from a recording medium and copies the read digital work, the digital work having embedded therein first copy information showing a restriction relating to copying the digital work, the copy apparatus comprising:
an acquisition unit operable to acquire second copy information that shows a restriction relating to copying the digital work; and
a display unit operable to generate, based on the acquired second copy information, display-use copy information expressing the restriction shown by the second copy information, and display the generated display-use copy information.

4. The copy apparatus of claim 3, wherein
the second copy information is recorded on the recording medium, and
the acquiring unit acquires the second copy information by reading the second copy information from the recording medium.

5. The copy apparatus of claim 4, wherein
the recording medium is rewritable, and
the copy apparatus further comprises:
an extraction unit operable to extract the first copy information from the digital work;
a judgement unit operable to compare the acquired second copy information and the extracted first copy information, and judge whether the restriction shown by the first copy information is stricter than the restriction shown by the second copy information; and
an update unit operable to, when the judgement unit judges that the restriction shown by the first copy information is stricter than the restriction shown by the second copy information, replace the second copy information with the first copy information.

6. The copy apparatus of claim 3 connected to a server apparatus via a network, and the server apparatus storing the second copy information in correspondence with the digital work,
wherein the acquisition unit acquires the second copy information from the server apparatus via the network.

7. The copy apparatus of claim 3 being connected to a server apparatus via a network, and the server apparatus storing the second copy information in correspondence with the digital work,
wherein the acquisition unit comprises:
a judgement sub-unit operable to judge whether the second copy information is recorded on the recording medium or not;
a first acquisition sub-unit operable to, when the judgement sub-unit judges that the second copy information is recorded on the recording medium, acquire the second copy information by reading the second copy information from the recording medium; and
a second acquisition operable to, when the judgement sub-unit judges that the second copy information is not recorded on the recording medium, acquire the second copy information from the server apparatus via the network.

8. The copy apparatus of claim 3, further comprising:
a storage unit operable to include an area for storing information; and
a writing unit operable to write the acquired second copy information to the storage unit in correspondence with the digital work.

9. The copy apparatus of claim 8, further comprising:
a copy judgement unit operable to judge, with use of the second copy information stored by the storage unit, whether copying of the digital work is permitted or not,
wherein the copy apparatus copies the digital work only when copying is permitted.

10. The copy apparatus of claim 9, further comprising:
an extraction unit operable to extract the first copy information from the digital work;
a judgement unit operable to compare the acquired second copy information and the extracted first copy information, and judge whether the restriction shown by the first copy information is stricter than the restriction shown by the second copy information; and
an update unit operable to, when the judgement unit judges that the restriction shown by the first copy information is stricter than the restriction shown by the second copy information, replace the second copy information with the first copy information.

11. The copy apparatus of claim 3, further comprising:
an input reception unit operable to receive input from a user; and
a reception restriction unit operable to, when during copying of the digital work the first copy information is detected to show that copying is prohibited, control the input reception unit so that input from the user is prohibited while a copy that has already been made of part of the digital work is being deleted.

12. The copy apparatus of claim 3, wherein
the digital work is composed of a predetermined number of information blocks,
the first copy information is composed of a predetermined number of pieces of first block copy information that correspond, respectively, to the predetermined number of information blocks, each of the predetermined number of pieces of the first block copy information being embedded in a corresponding one of the predetermined number of information blocks and showing a restriction relating to copying the corresponding one of the predetermined number of information blocks,
the second copy information is composed of a predetermined number of pieces of second block copy information that correspond, respectively, to the predetermined number information blocks, and
the display unit generates the display-use copy information based on the second copy information that is composed of the predetermined number of pieces of second block copy information.

13. A copy system comprising a copy apparatus and a recording medium on which a digital work is recorded, the copy apparatus reading the digital work from the recording medium and copying the read digital work, and the digital work having first copy information embedded therein showing a restriction relating to copying the digital work, the recording medium having information recorded thereon, the information comprising:
the digital work having the first copy information embedded therein; and
second copy information that shows a restriction relating to copying the digital work, and
the copy apparatus comprising:
an acquisition unit operable to acquire second copy information that shows a restriction relating to copying the digital work; and
a display unit operable to generate, based on the acquired second copy information, display-use copy information expressing the restriction shown by the second copy information, and display the generated display-use copy information.

14. A copy method used in a copy apparatus that reads a digital work from a recording medium and copies the read digital work, the digital work having embedded therein first copy information showing a restriction relating to copying the digital work, the copy method comprising:
an acquisition step of acquiring second copy information that shows a restriction relating to copying the digital work; and
a display step of generating, based on the acquired second copy information, display-use copy information expressing the restriction shown by the second copy information, and display the generated display-use copy information.

15. A computer program used in a copy apparatus that reads a digital work from a recording medium and copies the read digital work, the digital work having embedded therein first copy information showing a restriction relating to copying the digital work, the computer program comprising:
an acquisition step of acquiring second copy information that shows a restriction relating to copying the digital work; and
a display step of generating, based on the acquired second copy information, display-use copy information expressing the restriction shown by the second copy information, and display the generated display-use copy information.

16. A computer-readable program recording medium having recorded thereon a computer program used in a copy apparatus that reads a digital work from a recording medium and copies the read digital work, the digital work having embedded therein first copy information showing a restriction relating to copying the digital work, the computer program comprising:
an acquisition step of acquiring second copy information that shows a restriction relating to copying the digital work; and
a display step of generating, based on the acquired second copy information, display-use copy information expressing the restriction shown by the second copy information, and display the generated display-use copy information.
